(19) United States
(12) Patent Application Publication
(10) Pub. No.: US 2014/0025308 A1
(43) Pub. Date: Jan. 23, 2014

(54) ESTIMATION OF RECENT SHARED ANCESTRY

(71) Applicant: University of Utah Research Foundation, Salt Lake City, UT (US)

(72) Inventors: Lynn B. JORDE, Salt Lake City, UT (US); Chad D. HUFF, Salt Lake City, UT (US); David J. WITHERSPOON, Salt Lake City, UT (US)

(21) Appl. No.: 13/943,739

(22) Filed: Jul. 16, 2013

Related U.S. Application Data
(63) Continuation of application No. PCT/US2012/021573, filed on Jan. 17, 2012.
(60) Provisional application No. 61/433,921, filed on Jan. 18, 2011.

(51) Int. Cl. G06F 19/22

(52) U.S. Cl. CPC G06F 19/22
USPC 702/19

(57) ABSTRACT

Methods and systems are described for the estimation of recent shared ancestry (ERSA) from the number and lengths of identical-by-descent (IBD) nucleotide segments derived from, e.g., high-density single-nucleotide polymorphism data or whole-genome sequence data. ERSA is accurate to within one degree of relationship for 97% of first- through fifth-degree relatives and 80% of sixth- and seventh-degree relatives. ERSA's statistical power approaches the maximum theoretical limit imposed by the fact that distant relatives frequently share no DNA through a common ancestor. ERSA greatly expands the range of relationships that can be estimated from genetic data.

### CROSS-REFERENCE TO RELATED APPLICATIONS

This application is a continuation of International Patent Application No. PCT/US2012/021573, filed on Jan. 17, 2012, entitled ESTIMATION OF RECENT SHARED ANCESTRY, which claims the benefit of and priority to U.S. Provisional Application No. 61/433,921, filed on Jan. 18, 2011, the entire content of each of which is incorporated by reference herein.

### GOVERNMENT LICENSE RIGHTS

This invention was made with government support under K99 HG005846, R01 CA040641, N01 PC035141, P01CA073992, GM059290 and DK069513 awarded by National Institutes of Health. The government has certain rights in this invention.

### BACKGROUND

Knowledge about recent shared ancestry between individuals is fundamental to a wide variety of genetic studies. Detecting cryptic relatedness is a valuable technique for mapping disease-susceptibility loci and for identifying other at-risk individuals (Neklason et al. 2008; Thomas et al. 2008). For case-control association studies and population-based genetic analyses, related individuals should be identified and removed from samples that are intended to be random representatives of their populations (Pemberton et al. 2010; Simonson et al. 2010; Voight and Pritchard 2005; Xing et al. 2010). Using genetic data to correct pedigree errors increases the power of disease mapping in families (Cherny et al. 2001). Genetic identification of relatives has proven invaluable in forensic identification of missing persons, victims of mass disasters, and suspects in criminal investigations (Bieber et al. 2006; Biesecker et al. 2005; Zupanic Pajnic et al. 2010). Studies of conservation biology, quantitative genetics, and evolutionary biology are greatly illuminated when the recent shared ancestry between individuals being observed or sampled can be reconstructed, especially in agricultural and wild populations (DeWoody 2005; Slate et al. 2010).

### SUMMARY

Some embodiments of the disclosure include methods of estimating genetic relatedness between members of a first pair of conspecific organisms comprising receiving, by a processor, a value indicating a number of nonoverlapping polynucleotide segments longer than a threshold length (t) that are identical, by at least about 90 percent sequence identity, between members of the first pair; receiving, by a processor, values indicating lengths of the identical segments; comparing the number of the first pair's identical segments to a number of nonoverlapping polynucleotide segments longer than t that are identical, by at least about 90 percent sequence identity, between members of a second pair of organisms, the members of the second pair having an established degree of genetic relatedness to each other; comparing the lengths of the first pair's identical segments to lengths of nonoverlapping polynucleotide segments longer than t that are identical, by at least about 90 percent sequence identity, between members of a third pair of organisms, the members of the third pair having an established degree of genetic relatedness to each other; based on the number comparison and the length comparison, estimating, by a processor, a degree of genetic relatedness between the members of the first pair. In some embodiments, the members of the first pair are human. In certain embodiments, first pair's polynucleotide segments comprise DNA, mitochondrial DNA, sex-linked nucleotide segments, and/or RNA. In certain embodiments, t is equal to or greater than about 2.5 cM.

Some embodiments of the disclosure include methods of estimating genetic relatedness between members of a first pair of conspecific organisms further comprising comparing the lengths of the first pair's identical segments to a background distribution of lengths of nonoverlapping polynucleotide segments longer than t that are identical, by at least about 90 percent sequence identity, between members of pairs of organisms in a background group, the members of most pairs in the background group being more distantly related than fourth cousins; and wherein the estimating is further based on the comparison of the lengths of the first pair's identical segments to the lengths in the background distribution. In some embodiments the identical segments of the background group are no longer than about 10 cM. In certain embodiments members of the background group are selected randomly from a larger population.

In certain embodiments, the methods further comprise comparing the number of the first pair's identical segments to a first distribution, of numbers of nonoverlapping polynucleotide segments longer than t that are identical, by at least about 90 percent sequence identity, between members of pairs of organisms in a first group, the members of each pair in the first group having an established degree of genetic relatedness to each other; and wherein the estimating is further based on the comparison of the number of the first pair's identical segments to the numbers in the first distribution.

In some embodiments, the methods further comprise comparing the lengths of the first pair's identical segments to a second distribution, of lengths of nonoverlapping polynucleotide segments longer than t that are identical, by at least about 90 percent sequence identity, between members of pairs of organisms in a second group, the members of each pair in the second group having an established degree of genetic relatedness to each other; wherein the estimating is further based on the comparison of the lengths of the first pair's identical segments to the lengths in the second distribution.

In certain embodiments, the methods further comprise comparing the lengths of the first pair's identical segments to a second distribution, of lengths of nonoverlapping polynucleotide segments longer than t that are identical, by at least about 90 percent sequence identity, between members of pairs of organisms in a second group, the members of each pair in the second group having an established degree of genetic relatedness to each other; wherein the estimating is further based on the comparison of the lengths of the first pair's identical segments to the lengths in the second distribution. In some embodiments, the methods further comprise comparing the lengths of the first pair's identical segments to a background distribution, of lengths of nonoverlapping polynucleotide segments longer than t that are identical, by at least about 90 percent sequence identity, between members of pairs of organisms in a background group, the members of most pairs in the background group being more distantly related than fourth cousins; and wherein the estimating is further based on the comparison of the lengths of the first pair's identical segments to the lengths in the background distribution.

Some embodiments of the disclosure include methods of estimating genetic relatedness between members of a first pair of conspecific organisms wherein the estimating further comprises estimating a likelihood L_{P} that the first pair are no more related than two individuals selected randomly from a population, wherein: L_{P}(n,s|t)=N_{P}(n|t)·S_{P}(s|t); wherein

$${S}_{P} ( s \vert t ) = {\prod }_{i ∈ s} {F}_{P} ( i \vert t ) ;$$

wherein N_{P}(n|t) comprises the likelihood of sharing n segments, S_{P}(s|t) comprises the likelihood of the set of segments s, and F_{P}(i|t) comprises the likelihood of a segment of size i. In some embodiments, F_{P}(i|t) is approximated as

$${F}_{P} ( i \vert t ) = \frac{{e}^{- ( i \vert t ) / θ}}{θ} ;$$

wherein θ is equal to a mean shared segment size in the population for all segments of size greater than t and less than a maximum length. In some embodiments the maximum length is about 10 cM.

In some aspects, the estimating further comprises estimating a likelihood L_{R} that the first pair share one or two ancestors, wherein: L_{R}=L_{A}(n_{A},s_{A}|d,a,t)L_{P}(s_{P}|t); wherein n_{P}+n_{A}=n, where n_{A} is equal to the number of shared segments inherited from ancestors, n_{P} is the number of segments shared by the population; wherein s_{P} and s_{A} are two mutually exclusive subsets of s, where s_{A} is the subset of segments inherited from ancestor(s) with n_{A} elements, and s_{P} is the subset of segments shared by the population with n_{P} elements; wherein a represents the number of ancestors shared, and d represents the combined number of generations separating the individuals from their ancestor(s).

In some embodiments, the estimating further comprises estimating a likelihood L_{A} that the first pair share n segments from ancestor(s) specified by d and a, with the segment sizes specified by s_{A}, wherein: L_{A}(n_{A},s_{A}|d,a,t)=N_{A}(n|d,a,t)·S_{A}(s_{A}|d,t); wherein

$${S}_{A} ( s \vert d , t ) = {\prod }_{i ∈ s} {F}_{A} ( i \vert t ) ;$$

wherein N_{A}(n|d,a,t) is the likelihood of sharing n segments, S_{A}(s_{A}|d,t) is the likelihood of the set of segments s_{A}, and F_{A}(i|t) is the likelihood of a segment of size i; wherein s_{P} and s_{A} are two mutually exclusive subsets of s, where s_{A} is the subset of segments inherited from ancestor(s) with n_{A} elements, and s_{P} is the subset of segments shared by the population with n_{P} elements; wherein n_{P}+n_{A}=n, where n_{A} is equal to the number of shared segments inherited from ancestors, n_{P} is the number of segments shared by the population; wherein a represents the number of ancestors shared, and d represents the combined number of generations separating the individuals from their ancestor(s). In certain aspects, the estimating further comprises estimating a likelihood L_{A} that the first pair share n segments from ancestor(s) specified by d and a, with the segment sizes specified by s_{A}, wherein: L_{A}(n_{A},s_{A}|d,a,t)=N_{A}(n|d,a,t)·S_{A}(s_{A}|d,t); wherein

$${S}_{A} ( s \vert d , t ) = {\prod }_{i ∈ s} {F}_{A} ( i \vert t ) ;$$

wherein N_{A}(n|d,a,t) is the likelihood of sharing n segments, S_{A}(s_{A}|d,t) is the likelihood of the set of segments s_{A}, and F_{A}(i|t) is the likelihood of a segment of size i.

In some embodiments,

$${N}_{A} ( n \vert d , a , t ) = \frac{{{e}^{- \frac{a ( r d + c ) p ( t )}{{2}^{d - 1}}} [ \frac{a ( rd + c ) p ( t )}{{2}^{d - 1}} ]}^{n}}{n !} ;$$

wherein p(t) is the probability that a shared segment is longer than t, c comprises an average number of chromosomes in the organisms, and r comprises an average number of recombination events per haploid genome in the organisms. In certain embodiments, p(t) is assumed to be equal to or about e^{-dt/100}. In certain embodiments,

$${F}_{A} ( i \vert d , t ) = \frac{{e}^{- d ( i - t ) / 100}}{100 / d} .$$

In certain aspects, the estimating further comprises estimating a maximum likelihood of L_{R}(ML_{R}), wherein: ML_{R}(n_{P},n_{A},s|d,a,t)=N_{P}(n_{P}|t)N_{A}(n_{A}|d,a,t)·S_{P}({s_{1:n} . . . sₙ_{_{P}}_{:n}}|t)S_{A}({sₙ_{_{P}}_{+1:n} . . . s_{n:n}}|d,a,t); where s_{x:n} is equal to the x^{th} smallest value in s. In certain embodiments, the methods further comprise evaluating, by a processor, a ratio of ML_{R}(n_{P},n_{A},s|d,a,t) and L_{P}(n,s|t) using a chi-square approximation with two degrees of freedom. In some embodiments, the estimating further comprises estimating a maximum likelihood of L_{R}(ML_{R}), wherein: ML_{R}(n,s|d,a,t)=Max{MLR(n_{P},n−n_{P},s):n_{P} ∈ {0 . . . n}}.

In some embodiments, the methods of the invention further comprise receiving, by a processor, values indicating locations of the identical segments; comparing the locations of the first pair's identical segments to locations of nonoverlapping polynucleotide segments longer than t that are identical, by at least about 90 percent sequence identity, between members of a fourth pair of organisms, the members of the fourth pair having an established degree of genetic relatedness to each other; and wherein the estimating is further based on the location comparison. In some embodiments, the methods further comprise comparing the locations of the first pair's identical segments to a background distribution of locations of nonoverlapping polynucleotide segments longer than t that are identical, by at least about 90 percent sequence identity, between members of pairs of organisms in a background group, the members of most pairs in the background group being more distantly related than fourth cousins; and wherein the estimating is further based on the comparison of the locations of the first pair's identical segments to the locations in the background distribution.

In some embodiments, the methods further comprise comparing the locations of the first pair's identical segments to a first distribution, of locations of nonoverlapping polynucleotide segments longer than t that are identical, by at least about 90 percent sequence identity, between members of pairs of organisms in a first group, the members of each pair in the first group having an established degree of genetic relatedness to each other; and wherein the estimating is further based on the comparison of the locations of the first pair's identical segments to the locations in the first distribution.

Some embodiments of the disclosure include a computer-readable medium encoded with a computer program comprising instructions executable by a processor for estimating genetic relatedness between members of a first pair of conspecific organisms, the instructions including instruction code for: receiving, by a processor, a value indicating a number of nonoverlapping polynucleotide segments longer than a threshold length (t) that are identical, by at least about 90 percent sequence identity, between members of the first pair; receiving, by a processor, values indicating lengths of the identical segments; comparing the number of the first pair's identical segments to a number of nonoverlapping polynucleotide segments longer than t that are identical, by at least about 90 percent sequence identity, between members of a second pair of organisms, the members of the second pair having an established degree of genetic relatedness to each other; comparing the lengths of the first pair's identical segments to lengths of nonoverlapping polynucleotide segments longer than t that are identical, by at least about 90 percent sequence identity, between members of a third pair of organisms, the members of the third pair having an established degree of genetic relatedness to each other; based on the number comparison and the length comparison, estimating, by a processor, a degree of genetic relatedness between the members of the first pair. In some embodiments, the members of the first pair are human. In certain embodiments, first pair's polynucleotide segments comprise DNA, mitochondrial DNA, sex-linked nucleotide segments, and/or RNA. In certain embodiments, t is equal to or greater than about 2.5 cM.

In certain aspects, the computer-readable medium further comprises comparing the lengths of the first pair's identical segments to a background distribution of lengths of nonoverlapping polynucleotide segments longer than t that are identical, by at least about 90 percent sequence identity, between members of pairs of organisms in a background group, the members of most pairs in the background group being more distantly related than fourth cousins; and wherein the estimating is further based on the comparison of the lengths of the first pair's identical segments to the lengths in the background distribution. In some embodiments, the identical segments of the background group are no longer than about 10 cM. In certain embodiments the members of the background group are selected randomly from a larger population.

In some aspects, the medium further comprises comparing the number of the first pair's identical segments to a first distribution, of numbers of nonoverlapping polynucleotide segments longer than t that are identical, by at least about 90 percent sequence identity, between members of pairs of organisms in a first group, the members of each pair in the first group having an established degree of genetic relatedness to each other; and wherein the estimating is further based on the comparison of the number of the first pair's identical segments to the numbers in the first distribution.

In some embodiments, the medium further comprises comparing the lengths of the first pair's identical segments to a second distribution, of lengths of nonoverlapping polynucleotide segments longer than t that are identical, by at least about 90 percent sequence identity, between members of pairs of organisms in a second group, the members of each pair in the second group having an established degree of genetic relatedness to each other; wherein the estimating is further based on the comparison of the lengths of the first pair's identical segments to the lengths in the second distribution.

In certain aspects, the medium further comprises comparing the lengths of the first pair's identical segments to a second distribution, of lengths of nonoverlapping polynucleotide segments longer than t that are identical, by at least about 90 percent sequence identity, between members of pairs of organisms in a second group, the members of each pair in the second group having an established degree of genetic relatedness to each other; wherein the estimating is further based on the comparison of the lengths of the first pair's identical segments to the lengths in the second distribution.

In certain embodiments, the medium further comprises comparing the lengths of the first pair's identical segments to a background distribution, of lengths of nonoverlapping polynucleotide segments longer than t that are identical, by at least about 90 percent sequence identity, between members of pairs of organisms in a background group, the members of most pairs in the background group being more distantly related than fourth cousins; and wherein the estimating is further based on the comparison of the lengths of the first pair's identical segments to the lengths in the background distribution. In certain aspects, the estimating further comprises estimating a likelihood L_{P} that the first pair are no more related than two individuals selected randomly from a population, wherein: L_{P}(n,s|t)=N_{P}(n|t)·S_{P}(s|t); wherein

$${S}_{P} ( s \vert t ) = {\prod }_{i ∈ s} {F}_{P} ( i \vert t ) ;$$

wherein N_{P}(n|t) comprises the likelihood of sharing n segments, S_{P}(s|t) comprises the likelihood of the set of segments s, and F_{P}(i|t) comprises the likelihood of a segment of size i. In certain aspects, F_{P}(i|t) is approximated as:

$${F}_{P} ( i \vert t ) = \frac{{e}^{- ( i - t ) / θ}}{θ} ;$$

wherein θ is equal to a mean shared segment size in the population for all segments of size greater than t and less than a maximum length. In some embodiments, the maximum length is about 10 cM.

In some aspects of the computer-readable medium the estimating further comprises estimating a likelihood L_{R} that the first pair share one or two ancestors, wherein: L_{R}=L_{A}(n_{A},s_{A}|d,a,t)L_{P}(s_{P}|t); wherein n_{P}+n_{A}=n, where n_{A} is equal to the number of shared segments inherited from ancestors, n_{P} is the number of segments shared by the population; wherein s_{P} and s_{A} are two mutually exclusive subsets of s, where s_{A} is the subset of segments inherited from ancestor(s) with n_{A} elements, and s_{P} is the subset of segments shared by the population with n_{P} elements; wherein a represents the number of ancestors shared, and d represents the combined number of generations separating the individuals from their ancestor(s). In some embodiments the estimating further comprises estimating a likelihood L_{A} that the first pair share n segments from ancestor(s) specified by d and a, with the segment sizes specified by s_{A}, wherein: L_{A}(n_{A},s_{A}|d,a,t)=N_{A}(n|d,a,t)·S_{A}(s_{A}|d,t); wherein

$${S}_{A} ( s \vert d , t ) = {\prod }_{i ∈ s} {F}_{A} ( i \vert t ) ;$$

wherein N_{A}(n|d,a,t) is the likelihood of sharing n segments, S_{A}(s_{A}|d,t) is the likelihood of the set of segments s_{A}, and F_{A}(i|t) is the likelihood of a segment of size i; wherein s_{P} and s_{A} are two mutually exclusive subsets of s, where s_{A} is the subset of segments inherited from ancestor(s) with n_{A} elements, and s_{P} is the subset of segments shared by the population with n_{P} elements; wherein n_{P}+n_{A}=n, where n_{A} is equal to the number of shared segments inherited from ancestors, n_{P} is the number of segments shared by the population; wherein a represents the number of ancestors shared, and d represents the combined number of generations separating the individuals from their ancestor(s).

In some embodiments of the computer-readable medium, the estimating further comprises estimating a likelihood L_{A} that the first pair share n segments from ancestor(s) specified by d and a, with the segment sizes specified by s_{A}, wherein: L_{A}(n_{A},s_{A}|d,a,t)=N_{A}(n|d,a,t)·S_{A}(s_{A}|d,t); wherein

$${S}_{A} ( s \vert d , t ) = {\prod }_{i ∈ s} {F}_{A} ( i \vert t ) ;$$

wherein N_{A}(n|d,a,t) is the likelihood of sharing n segments, S_{A}(s_{A}|d,t) is the likelihood of the set of segments s_{A}, and F_{A}(i|t) is the likelihood of a segment of size i.

In certain aspects,

$${N}_{A} ( n \vert d , a , t ) = \frac{{{e}^{- \frac{a ( r d + c ) p ( t )}{{2}^{d - 1}}} [ \frac{a ( rd + c ) p ( t )}{{2}^{d - 1}} ]}^{n}}{n !} ;$$

wherein p(t) is the probability that a shared segment is longer than t, c comprises an average number of chromosomes in the organisms, and r comprises an average number of recombination events per haploid genome in the organisms. In certain embodiments, p(t) is assumed to be equal to or about e^{-dt/100}. In certain embodiments, of the computer-readable medium

$${F}_{A} ( i \vert d , t ) = \frac{{e}^{- d ( i - t ) / 100}}{100 / d} .$$

In certain aspects, the estimating further comprises estimating a maximum likelihood of L_{R}(ML_{R}), wherein: ML_{R}(n_{P},n_{A},s|d,a,t)=N_{P}(n_{P}|t)N_{A}(n_{A}|d,a,t)·S_{P}({s_{1:n} . . . sₙ_{_{P}}_{:n}}|t)S_{A}({sₙ_{_{P}}_{+1:n} . . . s_{n:n}}|d,a,t); where s_{x:n} is equal to the x^{th} smallest value in s. In some embodiments of the medium, evaluating further comprises evaluating, by a processor, a ratio of ML_{R}(n_{P},n_{A},s|d,a,t) and L_{P}(n,s|t) using a chi-square approximation with two degrees of freedom. In certain aspects, the estimating further comprises estimating a maximum likelihood of L_{R}(ML_{R}), wherein: ML_{R}(n,s|d,a,t)=Max{MLR(n_{P},n−n_{P},s):n_{P} ∈ {0 . . . n}}.

In some embodiments, the computer-readable medium further comprises receiving, by a processor, values indicating locations of the identical segments; comparing the locations of the first pair's identical segments to locations of nonoverlapping polynucleotide segments longer than t that are identical, by at least about 90 percent sequence identity, between members of a fourth pair of organisms, the members of the fourth pair having an established degree of genetic relatedness to each other; and wherein the estimating is further based on the location comparison.

In some aspects, the computer-readable medium further comprises comparing the locations of the first pair's identical segments to a background distribution of locations of nonoverlapping polynucleotide segments longer than t that are identical, by at least about 90 percent sequence identity, between members of pairs of organisms in a background group, the members of most pairs in the background group being more distantly related than fourth cousins; and wherein the estimating is further based on the comparison of the locations of the first pair's identical segments to the locations in the background distribution. In certain aspects, the computer-readable medium further comprises comparing the locations of the first pair's identical segments to a first distribution, of locations of nonoverlapping polynucleotide segments longer than t that are identical, by at least about 90 percent sequence identity, between members of pairs of organisms in a first group, the members of each pair in the first group having an established degree of genetic relatedness to each other; and wherein the estimating is further based on the comparison of the locations of the first pair's identical segments to the locations in the first distribution.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

All publications, patents, and GenBank sequences cited in this disclosure are incorporated by reference in their entirety.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIGS. 1A-1C. Expected distributions of IBD chromosomal segments between pairs of individuals. FIG. 1A: The process underlying the pattern of IBD segments. Two homologous autosomal chromosomes are shown for two parents, each colored differently. Meiosis and recombination occurs and two sibling offspring inherit recombinant chromosomes (just one crossover per homologous pair for each meiosis event is depicted, marked by an ‘X’). For some segments of the chromosome in question, the siblings share a stretch that was inherited from one of the four parental chromosomes. The three IBD segments are identifiable as regions that share the same color (boxed and marked at right by black bars). The siblings mate with unrelated individuals and the offspring each inherit an unrelated chromosome (tan or gray) and one that is a recombinant patchwork of the grandparental chromosomes. These first cousins share one segment IBD at this chromosome (red, boxed). FIG. 1B: The number of segments that a pair of individuals shares IBD, across all chromosomes, is approximately Poisson distributed with a mean that depends on the degree of relationship d between the individuals (d=2, 4, 6, 8, corresponding to siblings through third cousins). FIG. 1C: The lengths of the IBD segments are approximately exponentially distributed, with mean length depending on the relationship between individuals (theoretical distributions shown for d=2, 4, 6, 8).

FIGS. 2A-2D. Characteristics of HapMap CEU (Utah Americans of Northern and Western European descent) parents as a background reference population. FIG. 2A: Principal components analysis comparing 36 individuals from the three pedigrees set forth in Table 1 (no pair closer than seventh-degree relatives) to 85 unrelated individuals from three European populations (60 HapMap CEU parent-offspring trios and 25 HapMap TSI (Toscani in Italia) individuals) based on pairwise allele-sharing distances computed from ˜247,000 single-nucleotide polymorphisms (SNPs) typed on the Affymetrix SNP array (see Xing et al. 2010). The percentage of genetic variation explained by each component is given on the corresponding axis. FIG. 2B: Distribution of the number of segments with length≧2.5 cM that are inferred to be shared IBD by GERMLINE in pairs of CEU individuals (Observed), with fitted Poisson distribution (Expected). FIG. 2C: Distribution of the lengths of IBD segments longer than 2.5 cM in CEU pairs (Observed), with fitted exponential distribution (Expected). FIG. 2D: Scatterplot of the number of IBD segments per pair vs. mean length of segments in the pair.

FIGS. 3A and 3B. Estimated degree of relationship between pairs of individuals vs. known degree of relationship. FIG. 3A: Pedigree information was used to identify 2,802 pairs of genotyped individuals that share exactly two common ancestors (a mated pair) and classify them according to the degree of their relationship (horizontal axis). Within each category, the areas of the filled circles indicate the proportion of those pairs with various estimated degrees of relationship between a pair (vertical axis; two ancestors, two degrees of freedom, α=0.001). The total area within a category is a constant across categories. Pairs with a known but undetected relationship are represented across the top. Pairs with no known relationship are represented on the right. FIG. 3B: The number of pairs in each category is indicated by the histogram below.

FIG. 4. Power to detect recent common ancestry between pairs of individuals known to be related at varying degrees. Each pair of individuals has exactly two known ancestors in the pedigree, and both inheritance paths connecting the pair (one through each ancestor) have the same number of meioses in them. Maximum theoretical power is shown by the solid black line (the probability that a pair of individuals with the given relationship are genetically related at all, calculated from Eq. 7 with a=2 and t=0). The power of ERSA using IBD segments estimated by GERMLINE, with α=0.05 and α=0.001 (2 degrees of freedom d.f.), is indicated by the dotted and solid red lines respectively. Using IBD segments estimated by fastIBD of the Beagle 3.3 package available on Sharon Browning's or Brian Browning's University of Washington webpages), ERSA achieves the power shown by the green line (α=0.001, 2 d.f.). The power of RELPAIR (Epstein et al. 2000) to detect a relationship is indicated by the dotted blue line (using 9,990 evenly-spaced autosomal markers with minor allele frequency (MAF)>0.4, default likelihood ratio (LR) threshold of 10 for reporting a relationship as significant). The power of GBIRP (Stankovich et al. 2005) is shown by the solid blue line (10,028 evenly-spaced autosomal markers with MAF>0.4, LOD threshold of 2.34 for significance as in Stankovich et al. 2005, corresponding to α=0.001 with 1 d.f.).

FIGS. 5A-5C: ERSA's power and accuracy for one-ancestor relationships. FIGS. 3 and 4 display results for all known two-ancestor relationships in the pedigree where the two inheritance paths are the same length, such as full siblings and full cousins. This figure displays the equivalent results for all relationships with exactly one known one-ancestor relationships, i.e. half siblings and half cousins. FIG. 5A: Known vs. estimated degree of relationship. FIG. 5B: Number of pairs in the pedigree with the specified known degree of relationship. FIG. 5C: Power to detect a significant relationship at the α=0.001 significance level plotted against the maximum theoretical power (calculated from Eq. 7 with a=1 and t=0).

FIGS. 6A-6F: Known vs. estimated degree of relationship for individuals that share exactly two common ancestors and where both paths connecting the pair have the same length, using (A) ERSA with α=0.05 based on IBD segments estimated by GERMLINE (Gusev et al. 2009) IBD segments (FIG. 6A); (B) ERSA with α=0.001 and GERMLINE IBD segments (FIG. 6B; same as FIG. 3); (C) ERSA with α=0.05 and Beagle 3.3 fastIBD (available on Sharon Browning's or Brian Browning's University of Washington webpages)) segments (FIG. 6C); (D) GBIRP and 10,028 evenly-spaced SNPs with MAF>0.4, with a LOD threshold of 2.34 for significance (as in Stankovich et al. 2005) (FIG. 6D); and (E) RELPAIR with 9,990 evenly-spaced SNPs and requiring a likelihood ratio>10 for significance (the default in RELPAIR; Epstein et al. 2000) (FIG. 6E). FIG. 6F: The number of pairs in each relationship class. For GBIRP analysis, SNP data was thinned (following Berkovic et al. 2008) after phasing and imputation as described in Methods, then written to GBIRP-readable data format files (fdist, ffreq, fhaplos, and fLastMarkers; available on the Walter+Eliza Hall Institute of Medical Research Bioinformatics/GBIRP webpages), with allele frequencies estimated from the entire sample of 169 individuals. GBIRP analyses were performed with various numbers of markers (from 1,000 to 50,000) with different minimum MAF values (from 0.1 to 0.4); the optimal results are shown.

FIGS. 7A and 7B: Performance of ERSA's nominal 95% (FIG. 7A) and 99% (FIG. 7B) confidence intervals (C.I.). The proportion of pairs for which the nominal C.I. contains the known value is plotted vs. the known relationship (degree of relationship for a pair of individuals that share two common ancestors, where both paths through those ancestors have the same length, with a=2).

FIG. 8: Realized vs. expected sums of shared IBD segment lengths between pairs of related individuals sharing exactly two ancestors. The dotted lines enclose the middle 90% of observed values. The expectation for the sum of IBD segment lengths (dashed line) is adjusted to account for the fact that IBD segments detected by GERMLINE do not distinguish between haploid and diploid sharing and for the expected overlap of IBD segments in siblings.

FIG. 9: Bioinformatic merging of shared segments in full siblings. Two homologous autosomal chromosomes are shown for two parents, each colored differently. Meiosis and recombination occurs and two sibling offspring inherit recombinant chromosomes. Although the siblings share three distinct IBD segments, two of these segments overlap and are thus merged bioinformatically (by GERMLINE or BEAGLE) into a single shared segment (black bar, far right). Eq. S1 and S2 account for this process of bioinformatic merging.

FIG. 10: The effect of allowing a to vary under the null model. The cumulative probability for values of the observed LRT statistic comparing models with a free to vary or fixed equal to 2 is shown in blue. The cumulative distribution for a χ² distribution with one degree of freedom is shown in red for comparison.

TABLE 1
Proportions of the total possible number of ancestors of the 169 genotyped
individuals up to a given depth (in generations) that are listed in the three
pedigrees. For example, for the combined dataset (the 1^{st} column),
99.4% of the second-generation ancestors of the 169 genotyped individuals
are included in the pedigree.

| | Proportion of ancestors in pedigree | | | |
|---|---|---|---|---|
| | | | | Pedigree 3 |
| | Combined | Pedigree 1 | Pedigree 2 | (24; |
| Generation | (169; 61,569) | (115; 58,329)* | (30; 2,017)* | 1,223)* |
| 1 | 1 | 1 | 1 | 1 |
| 2 | 0.994 | 0.991 | 1 | 1 |
| 3 | 0.966 | 0.972 | 0.967 | 0.938 |
| 4 | 0.917 | 0.952 | 0.958 | 0.698 |
| 5 | 0.744 | 0.823 | 0.665 | 0.461 |
| 6 | 0.594 | 0.692 | 0.424 | 0.335 |
| 7 | 0.448 | 0.538 | 0.284 | 0.224 |
| 8 | 0.300 | 0.369 | 0.180 | 0.119 |
| 9 | 0.190 | 0.237 | 0.115 | 0.0537 |
| 10 | 0.109 | 0.144 | 0.0432 | 0.0221 |
| 11 | 0.0598 | 0.0838 | 0.00934 | 0.00757 |
| 12 | 0.0305 | 0.0438 | 0.00202 | 0.00226 |
| 13 | 0.0131 | 0.0190 | 0.000456 | 0.000702 |
| 14 | 0.00446 | 0.00650 | 3.26 × 10⁻⁵ | 0.000178 |

*Number of individuals from this pedigree that were genotyped, number of individuals listed in the pedigree.

TABLE 2
False positive rate of detecting recent ancestry among HapMap JPT-CHB
pairs

| Nominal false | Observed false | Observed false |
|---|---|---|
| positive rate | positive rate | positive counts |
| 0.05 | 0.044 | 89/2,025 |
| 0.01 | 0.0094 | 19/2,025 |
| 0.001 | 0.00049 | 1/2,025 |

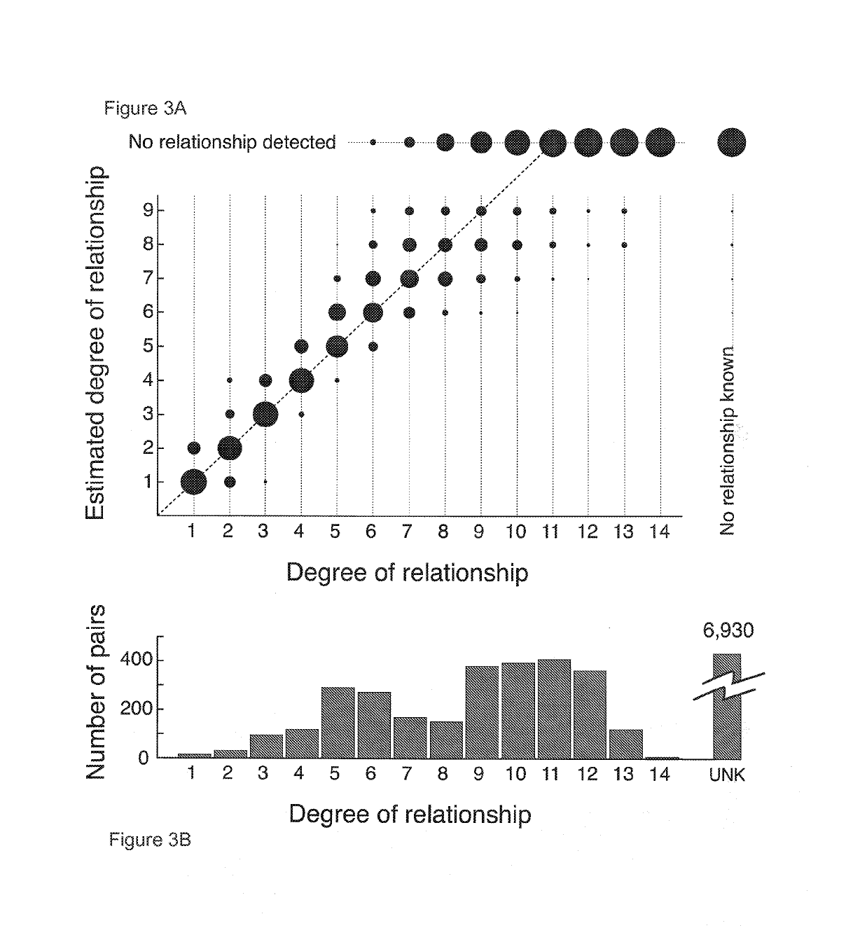

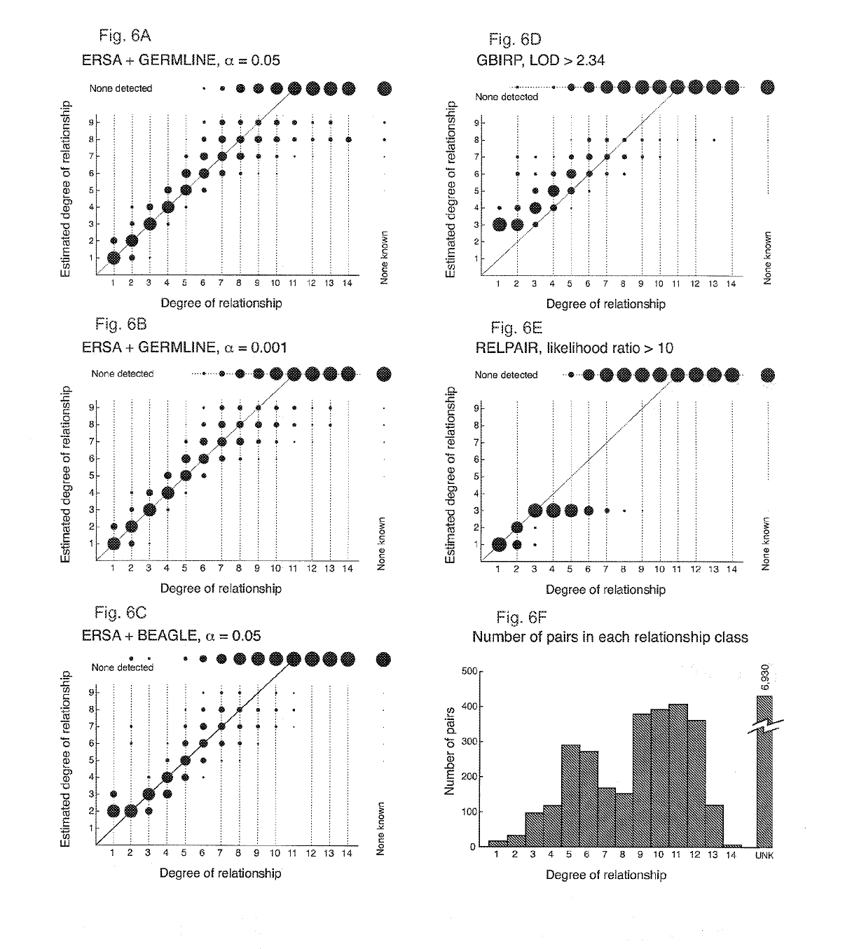

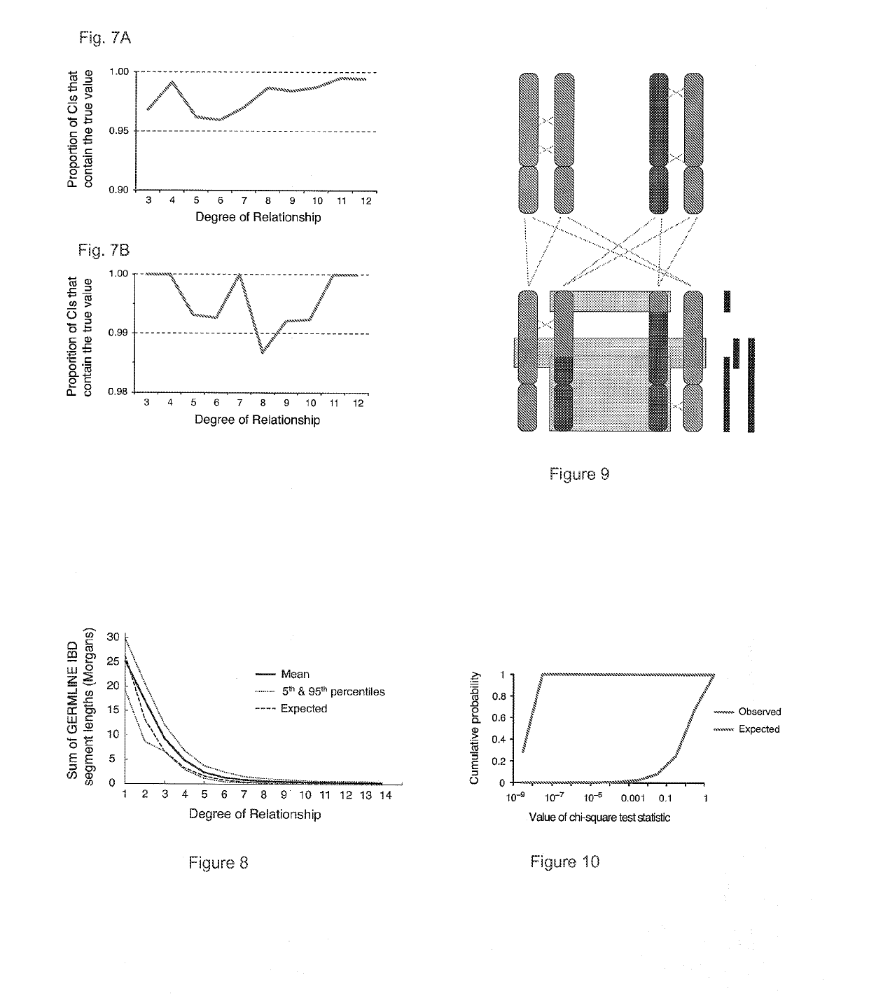

TABLE S1
Data of FIGS. 6A-6F and FIGS. 3A and 3B.

| | Known degree of relationship | | | | | | | | | | | | | | |
|---|---|---|---|---|---|---|---|---|---|---|---|---|---|---|---|
| Estimated | | | | | | | | | | | | | | | None |
| degree | 1 | 2 | 3 | 4 | 5 | 6 | 7 | 8 | 9 | 10 | 11 | 12 | 13 | 14 | known |

ERSA + GERMLINE, α = 0.05

| | | | | | | | | | | | | | | | |
|---|---|---|---|---|---|---|---|---|---|---|---|---|---|---|---|
| None | | | | | | 6 | 14 | 53 | 180 | 263 | 339 | 334 | 103 | 6 | 6584 |
| detected | | | | | | | | | | | | | | | |
| 9 | | | | | | 10 | 20 | 15 | 63 | 48 | 36 | 10 | 7 | | 133 |
| 8 | | | | | 1 | 25 | 41 | 39 | 94 | 64 | 28 | 16 | 8 | 1 | 184 |
| 7 | | | | | 16 | 75 | 65 | 38 | 38 | 15 | 4 | 1 | | | 25 |
| 6 | | | | | 102 | 126 | 28 | 6 | 4 | 1 | | | | | 3 |
| 5 | | | | 28 | 164 | 29 | | | | | | | | | 1 |
| 4 | | 1 | 19 | 85 | 7 | | | | | | | | | | |
| 3 | | 3 | 75 | 4 | | | | | | | | | | | |
| 2 | 3 | 23 | | | | | | | | | | | | | |
| 1 | 12 | 5 | 1 | | | | | | | | | | | | |

ERSA + GERMLINE, α = 0.001 (data of FIGS. 3A and 3B)

| | | | | | | | | | | | | | | | |
|---|---|---|---|---|---|---|---|---|---|---|---|---|---|---|---|
| None | | | | | | 10 | 21 | 57 | 213 | 296 | 360 | 350 | 110 | 7 | 6829 |
| detected | | | | | | | | | | | | | | | |
| 9 | | | | | | 7 | 15 | 14 | 44 | 34 | 23 | 5 | 4 | | 33 |
| 8 | | | | | 1 | 24 | 39 | 36 | 80 | 46 | 20 | 5 | 4 | | 46 |
| 7 | | | | | 16 | 75 | 65 | 38 | 38 | 14 | 4 | 1 | | | 18 |
| 6 | | | | | 102 | 126 | 28 | 6 | 4 | 1 | | | | | 3 |
| 5 | | | | 28 | 164 | 29 | | | | | | | | | 1 |
| 4 | | 1 | 19 | 85 | 7 | | | | | | | | | | |
| 3 | | 3 | 75 | 4 | | | | | | | | | | | |
| 2 | 3 | 23 | | | | | | | | | | | | | |
| 1 | 12 | 5 | 1 | | | | | | | | | | | | |

ERSA + BEAGLE, α = 0.001

| | | | | | | | | | | | | | | | |
|---|---|---|---|---|---|---|---|---|---|---|---|---|---|---|---|
| None | | 2 | 2 | | 17 | 64 | 74 | 105 | 323 | 360 | 397 | 361 | 118 | 7 | 6907 |
| detected | | | | | | | | | | | | | | | |
| 9 | | | | | | 4 | 4 | 4 | 4 | 7 | 2 | | | | 5 |
| 8 | | | | | 3 | 17 | 27 | 18 | 22 | 13 | 7 | | | | 8 |
| 7 | | 1 | | | 14 | 55 | 39 | 15 | 25 | 11 | 1 | | | | 5 |
| 6 | | 1 | | 1 | 48 | 87 | 22 | 8 | 5 | | | | | | 3 |
| 5 | | | | 7 | 137 | 39 | 2 | 1 | | | | | | | 2 |
| 4 | | | 3 | 68 | 71 | 5 | | | | | | | | | |
| 3 | 3 | | 68 | 41 | | | | | | | | | | | |
| 2 | 12 | 28 | 22 | | | | | | | | | | | | |
| 1 | | | | | | | | | | | | | | | |

GBIRP, LOD >2.34

| | | | | | | | | | | | | | | | |
|---|---|---|---|---|---|---|---|---|---|---|---|---|---|---|---|
| None | | 1 | | 4 | 63 | 149 | 127 | 123 | 353 | 378 | 405 | 359 | 116 | 7 | 6905 |
| detected | | | | | | | | | | | | | | | |
| 9 | | | | | | | | | | | | | | | |
| 8 | | | | | 2 | 19 | 10 | 9 | 12 | 6 | 2 | 2 | 2 | | 18 |
| 7 | | 1 | 2 | 1 | 33 | 47 | 23 | 15 | 14 | 7 | | | | | 6 |
| 6 | | 2 | 3 | 14 | 120 | 50 | 8 | 4 | | | | | | | |
| 5 | | | 15 | 74 | 68 | 6 | | | | | | | | | 1 |
| 4 | 1 | 5 | 62 | 24 | 4 | | | | | | | | | | |
| 3 | 14 | 23 | 13 | | | | | | | | | | | | |
| 2 | | | | | | | | | | | | | | | |
| 1 | | | | | | | | | | | | | | | |

RELPAIR, likelihood ratio >10

| | | | | | | | | | | | | | | | |
|---|---|---|---|---|---|---|---|---|---|---|---|---|---|---|---|
| None | | | | | 40 | 164 | 150 | 147 | 376 | 391 | 405 | 361 | 118 | 7 | 6924 |
| detected | | | | | | | | | | | | | | | |
| 3+ | | | 90 | 117 | 250 | 107 | 18 | 4 | 3 | | 2 | | | | 6 |
| 2 | | 20 | 2 | | | | | | | | | | | | |
| 1 | 15 | 12 | 3 | | | | | | | | | | | | |

TABLE S2
Number of pairs in each relationship degree class (data of lower panel of FIGS. 3A and 3B)

| | Known degree of relationship | | | | | | | | | | | | | | |
|---|---|---|---|---|---|---|---|---|---|---|---|---|---|---|---|
| | | | | | | | | | | | | | | | None |
| | 1 | 2 | 3 | 4 | 5 | 6 | 7 | 8 | 9 | 10 | 11 | 12 | 13 | 14 | known |
| Number of | 15 | 32 | 95 | 117 | 290 | 271 | 168 | 151 | 379 | 391 | 407 | 361 | 118 | 7 | 6930 |
| pairs | | | | | | | | | | | | | | | |

TABLE S4
Percent detection power for various methods (data of FIGS. 3A and 3B)

| | Degree of relationship known | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Maximum | 100 | 100 | 100 | 100 | 100 | 99.98 | 99.14 | 92.94 | 76.85 | 55.08 | 35.25 | 20.91 | 11.83 | 6.5 |
| Theoretical | | | | | | | | | | | | | | |
| Power | | | | | | | | | | | | | | |
| ERSA + | 100 | 100 | 100 | 100 | 100 | 97.79 | 91.67 | 64.9 | 52.51 | 32.74 | 16.71 | 7.48 | 12.71 | 14.29* |
| GERMLIN | | | | | | | | | | | | | | |
| E, a = 0.05 | | | | | | | | | | | | | | |
| ERSA + | 100 | 100 | 100 | 100 | 100 | 96.31 | 87.5 | 62.25 | 43.8 | 24.3 | 11.55 | 3.05 | 6.78 | 0 |
| GERMLIN | | | | | | | | | | | | | | |
| E, a = | | | | | | | | | | | | | | |
| 0.001 | | | | | | | | | | | | | | |
| ERSA + | 100 | 93.75 | 97.89 | 100 | 94.14 | 76.38 | 55.95 | 30.46 | 14.78 | 7.93 | 2.46 | 0 | 0 | 0 |
| BEAGLE, | | | | | | | | | | | | | | |
| a = 0.001 | | | | | | | | | | | | | | |
| GBIRP | 100 | 96.88 | 100 | 96.58 | 78.28 | 45.02 | 24.4 | 18.54 | 6.86 | 3.32 | 0.49 | 0.55 | 1.69 | 0 |
| RELPAIR | 100 | 100 | 100 | 100 | 86.21 | 39.48 | 10.71 | 2.65 | 0.79 | 0 | 0.49 | 0 | 0 | 0 |

*For very distant relationships, estimated power sometimes exceeds the maximum expected power. This is likely due to the existence of some undocumented distant relationships, since the pedigrees are not complete at such depths, as well as to false positive results.

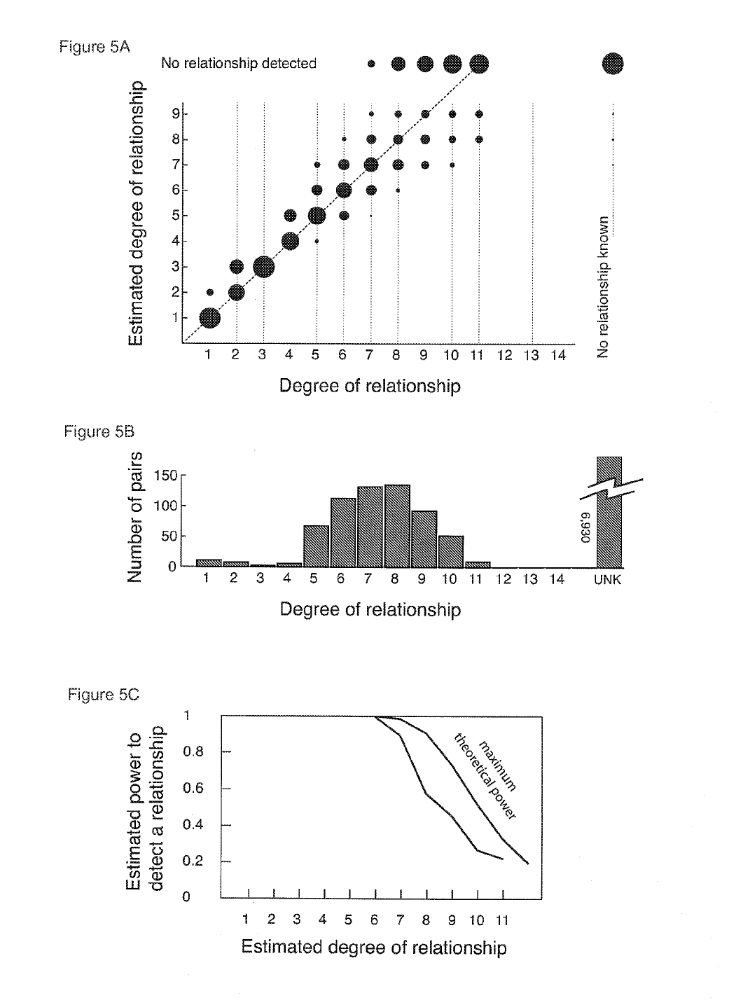

TABLE S5
ERSA + GERMLINE, α = 0.001, one-ancestor model and data set (data of FIGS. 5A-5C)

| | Known degree of relationship | | | | | | | | | | | |
|---|---|---|---|---|---|---|---|---|---|---|---|---|
| Estimated | | | | | | | | | | | | None |
| degree | 1 | 2 | 3 | 4 | 5 | 6 | 7 | 8 | 9 | 10 | 11 | known |
| None | | | | | | | 14 | 57 | 50 | 38 | 7 | 6826 |
| detected | | | | | | | | | | | | |
| 9 | | | | | | | 6 | 13 | 13 | 6 | 1 | 33 |
| 8 | | | | | | 4 | 24 | 27 | 17 | 6 | 1 | 45 |
| 7 | | | | | 5 | 29 | 58 | 34 | 12 | 2 | | 22 |
| 6 | | | | | 16 | 59 | 29 | 4 | | | | 2 |
| 5 | | | | 2 | 44 | 21 | 1 | | | | | |
| 4 | | | | 4 | 2 | | | | | | | |
| 3 | | 3 | 2 | | | | | | | | | |
| 2 | 1 | 4 | | | | | | | | | | |
| 1 | 10 | | | | | | | | | | | |
| Number | 11 | 7 | 2 | 6 | 67 | 113 | 132 | 135 | 92 | 52 | 9 | 6930 |
| of Pairs | | | | | | | | | | | | |
| Estimated | 100 | 100 | 100 | 100 | 100 | 100 | 89.39 | 57.78 | 45.65 | 26.92 | 22.22 | |
| Power | | | | | | | | | | | | |

TABLE S6
Estimates of significant recent ancestry (α = 0.001) among pairs of parent individuals in the
HapMap CEU dataset.

| | | | | 99.9% | | | |
|---|---|---|---|---|---|---|---|
| | | Estimated | | Confidence | | | |
| | | number of | | Interval for the | | | |
| | | shared | Estimated | degree of | | | |
| | | ancestors | degree of | relationship | | — | — |
| Individual 1 | Individual 2 | (a) | relationship | a = 2 | a = 1 | lnL(Related) | lnL(Unrelated) |
| NA12154 | NA12892 | 2 | 9 | 6-21 | 6-21 | 12.90 | 19.98 |
| NA06985 | NA12812 | 1 | 7 | 5-13 | 5-13 | 23.86 | 67.49 |
| NA06993 | NA07022 | 2 | 4 | 3-6 | 3-6 | 81.95 | 499.50 |
| NA11995 | NA12145 | 2 | 8 | 5-16 | 5-16 | 16.74 | 26.85 |
| NA11840 | NA12717 | 2 | 8 | 6-16 | 5-16 | 15.70 | 30.77 |
| NA12056 | NA12872 | 2 | 8 | 5-13 | 5-13 | 18.67 | 27.12 |
| NA07034 | NA12145 | 1 | 9 | 6-19 | 5-19 | 16.33 | 37.98 |
| NA12146 | NA12812 | 2 | 8 | 5-19 | 5-19 | 21.11 | 30.25 |
| NA11881 | NA12762 | 2 | 8 | 5-17 | 5-17 | 14.62 | 23.63 |
| NA06993 | NA07056 | 2 | 4 | 3-6 | 3-6 | 85.14 | 510.44 |
| NA11993 | NA12239 | 2 | 8 | 6-18 | 5-18 | 17.78 | 27.13 |
| NA11829 | NA12815 | 2 | 7 | 5-13 | 5-13 | 22.46 | 32.26 |
| NA07034 | NA11882 | 2 | 6 | 5-8 | 4-8 | 33.72 | 139.83 |
| NA07000 | NA12057 | 2 | 8 | 5-18 | 5-18 | 23.27 | 42.08 |
| NA12155 | NA12264 | 2 | 4 | 3-5 | 3-5 | 103.79 | 631.83 |
| NA12006 | NA12155 | 2 | 9 | 6-20 | 6-20 | 10.12 | 19.43 |
| NA07034 | NA12750 | 2 | 8 | 5-19 | 5-19 | 20.75 | 41.10 |
| NA12236 | NA12716 | 1 | 9 | 5-17 | 5-17 | 18.32 | 60.64 |
| NA06994 | NA07000 | 1 | 9 | 6-17 | 5-18 | 13.29 | 49.92 |
| NA07022 | NA07056 | 2 | 8 | 5-18 | 5-18 | 19.80 | 35.36 |
| NA12043 | NA12760 | 2 | 8 | 6-18 | 5-18 | 12.42 | 19.73 |
| NA11994 | NA12146 | 2 | 8 | 5-19 | 5-19 | 15.21 | 24.71 |
| NA06994 | NA12892 | 2 | 5 | 4-7 | 4-6 | 65.19 | 296.69 |

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

### 1. Overview

Most established methods for detecting and estimating genetic relationships are based on genome-wide averages of the estimated number of alleles shared that are identical by descent (IBD) between two individuals (Weir et al. 2006). These methods are accurate and efficient for relationships as distant as third-degree relatives (e.g., first cousins) but cannot identify more distant relationships. In contrast, aspects of the instant disclosure provide novel methods and apparatus of estimation of recent shared ancestry (ERSA) that accurately estimate the degree of relationship for up to eighth-degree relatives (e.g., third cousins once removed), and detect relationships as distant as twelfth-degree relatives (e.g., fifth cousins once removed).

Some methods of detecting relatedness (for example, the method implemented in PLINK; Purcell et al. 2007) rely on genome-wide averages of genetic identity coefficient estimates. These statistics incompletely summarize the information contained in the IBD segment data: genetic identity coefficients can be calculated from IBD segment data, but the reverse is not true. To illustrate the importance of this difference, the typical amount of genetic sharing between a pair of fourth cousins is considered. The probability that fourth cousins share at least one IBD segment is 77%, and the expected length of this segment is 10 centiMorgans (cM) (Donnelly 1983). Because a 10 cM segment represents less than 0.3% of the genome, this excess of IBD has very little effect on estimates of relatedness averaged over the genome. However, because unrelated individuals are unlikely to share a 10 cM segment in most populations, the novel ERSA methods and apparatus disclosed herein are capable of detecting many fourth-cousin relationships.

Another family of methods for detecting relationships models the IBD states between haplotypes as a Markov process along a chromosome, with different transition probability matrices corresponding to different hypothesized relationships. The likelihoods of various relationship models are then estimated from the data. Examples of these methods include RELPAIR (Boehnke and Cox 1997; Epstein et al. 2000), PREST (extending the methods in Boehnke and Cox, 1997; McPeek and Sun 2000; Sun et al. 2002), and GBIRP (extending PREST to the problem of general relationship estimation; Stankovich et al. 2005). These tools were initially designed for use with hundreds of microsatellite loci spaced at intervals of several cM, but they have also been applied to high-density single-nucleotide polymorphism (SNP) data (e.g., Berkovic et al. 2008; Pemberton et al. 2010). However, they do not model the patterns of linkage disequilibrium (LD) that exist between very closely spaced SNP markers and instead assume that markers are not in strong LD. High-density SNP data sets must be thinned to approximately 10,000 markers before they can be used (see, e.g., Berkovic et al. 2008; Pemberton et al. 2010). The key information used by such Markov-process methods is the match between the hypothesized transition probability matrix and the pattern of IBD state transitions induced by the genotype data.

In contrast, some embodiments of the instant ERSA methods and apparatus use explicit IBD segment information to estimate the relationships between pairs of individuals in a maximum-likelihood framework. This makes better use of the information present in high-density SNP genotyping data. The power of ERSA disclosed herein to detect relationships between second cousins or closer relatives is essentially perfect and exceeds 85% for third cousins even at the α=0.001 level. ERSA is also more accurate than RELPAIR or GBIRP.

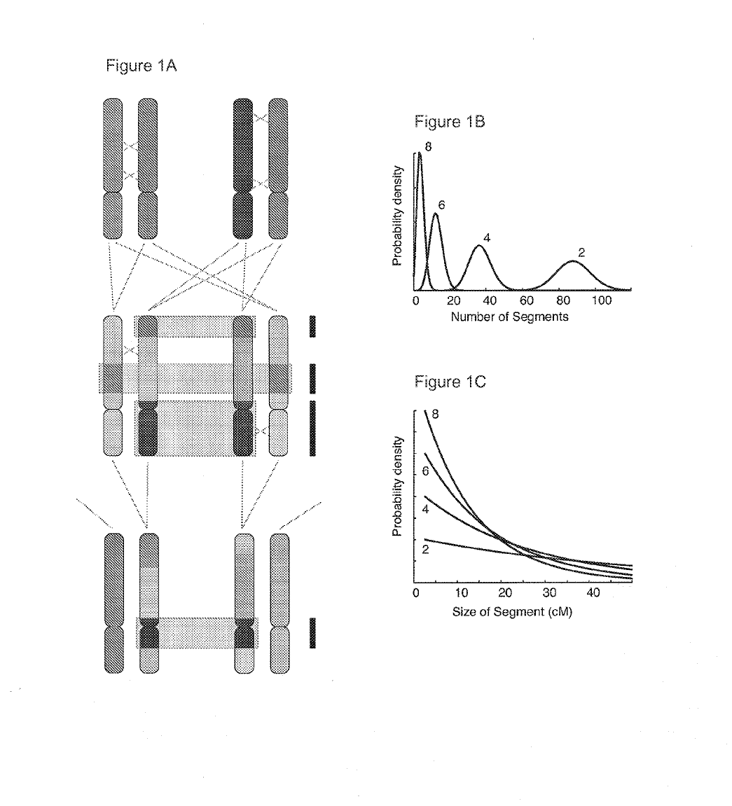

The number, lengths, and locations of chromosomal segments that are shared IBD by a pair of individuals essentially constitute the genetic information that bears on their recent shared genetic ancestry. FIG. 1 illustrates the process that generates IBD segments and shows how the expected distributions of segment number and length depend on the relationship between two individuals.

Algorithms can be used to detect the number, lengths, and locations of chromosomal segments IBD between two individuals. (Browning and Browning 2010; Gusev et al. 2009; Thomas et al. 2008) In some embodiments, ERSA uses a likelihood ratio test to compare the null hypothesis that the two individuals are unrelated with the alternative hypothesis that the individuals share recent ancestry. Because of the qualitative difference between genome-wide averages of relatedness and the information contained in IBD segments, aspects of the present disclosure greatly expand the range of relationships that can be detected from genetic data.

ERSA is immediately applicable to a number of problems. It can be used to identify cryptic relatedness between individuals with the same rare genetic disorder. In analyzing large pedigrees, ERSA can verify distant relationships without genotyping intervening family members. This can sharply reduce sample collection and genotyping requirements.

In the forensic field, a common DNA-based method for identifying the remains of missing persons is based on comparisons of kinship statistics computed from a modest number (13-17) of STR loci, with useful comparisons generally limited to second-degree relationships (Alonso et al. 2005; e.g., MDKAP, Leclair et al. 2007; M-FISys, Budimlija et al. 2003; Cash et al. 2003). The International Commission on Missing Persons (ICMP) has generated matches for more than 18,000 persons missing from armed conflicts or mass disasters at a significance level exceeding 99.95% (personal communication from T J Parsons, ICMP). However, this level of certainty requires typing multiple first- or second-degree relatives. Such close relatives are often unavailable, due either to disasters and conflicts that disperse entire families or to the passage of time (Brenner 2006; Leclair 2004). For example, DNA profiles exist for over 2,000 individuals killed in the armed conflict in Bosnia for which identifications cannot be made due to insufficient family reference samples (T J Parsons, ICMP). ERSA allows the use of a much larger pool of distant relatives (Bieber et al. 2006) and enables definitive conclusions to be drawn based on single closer relatives. For the first time, with ERSA, even a single individual searching for a family member would be able to provide a definitive reference.

The methods described here are computationally efficient, make near-optimal use of the genetic signal of relatedness between individuals, achieve a statistical power very close to the theoretical maximum and have multiple applications. These methods can be implemented by machine-readable code, e.g., in software or hardware, and over computer networks such as the Internet.

### 2. Identical by Descent

As used herein, “IBD-segments” are nonoverlapping polynucleotide segments longer than a threshold length (t) that are identical, in certain embodiments, by at least about 90% identical; in certain embodiments about 95% identical; in certain embodiments about 98% identical; in certain embodiments about 99% identical; and in certain embodiments about 100% identical.

Any IBD segment number and length data can be used in aspects of the present disclosure. Likewise, any IBD segment detection method can be used. Examples of software programs for IBD segment detection are GERMLINE (Gusev et al. 2009); fastIBD in Beagle 3.3 (Browning and Browning 2010), MERLIN (via—extended, Abecasis et al.) and Thompson (tech report, U Wash). IBD segments are determined using, for example, SNP data, whole-genome sequencing data, and/or higher-density microarray data.

### 3. Polynucleotides

As used herein, “polynucleotides” are in certain embodiments deoxyribonucleic acids (DNA), in certain embodiments ribonucleic acids (RNA), in certain embodiments mitochondrial DNA (mtDNA), in certain embodiments sex-linked nucleotide segments, such as those found on the Y or X chromosomes.

In certain embodiments, autosomal segments is a source of the polynucleotides used in estimating recent shared ancestry. In certain embodiments, RNA is a source of the polynucleotides used in estimating recent shared ancestry.

In certain embodiments, mtDNA or the Y chromosome(s) is a source of the polynucleotides used in estimating recent shared ancestry. For a hypothesized alternative relationship with a ancestors on a path d meioses long, the likelihood of the observed mtDNA or Y chromosome data is computed by integrating over all possible pedigrees with a ancestors and d meioses, specifying the sex of each individual in the inheritance path so that the probabilities can be calculated. The likelihood of the null hypothesis (no relationship) is calculated based on the frequencies of the observed mtDNA or Y chromosome haplotypes in the background population. In both calculations, an allowance is made for an appropriate genotyping or sequencing error rate. The log-likelihoods based on the mtDNA and Y chromosome data are then added to the log-likelihoods computed from the autosomal data (for the corresponding null and alternative hypotheses), and the relationship is estimated using standard likelihood theory as before.

In certain embodiments, the X chromosome(s) is a source of the polynucleotides used in estimating recent shared ancestry. IBD segment data from the X chromosome is used in a similar way as Y chromosome and mtDNA data. To calculate the likelihood of the null hypothesis given observed X chromosome SNP genotype or sequence data, the observed IBD segments are compared to distributions estimated from unrelated individuals in the source population. For each alternative hypothesis, likelihoods are calculated by integrating over all possible sex-specified pedigrees in the class of relationships with a ancestors on a path d meioses long. This allows the method to account for the number of meioses in the path in which recombination occurred (only in females), which determines the IBD segments length distribution, and for the probability that the ancestral X chromosome is lost altogether (due to two consecutive male parents in the inheritance path.) The log-likelihoods for null and alternative hypotheses based on X chromosome data are added to the log-likelihoods for the autosomal data, and the final likelihood ratio test is carried out as before.

### 4. Definitions

As used herein, the term “ancestor” is a parent or, recursively, the parent of an ancestor, e.g., a grandparent, great-grandparent, or great-great-grandparent.

As used herein, the term “random selection” is a broad term that includes, without limitation, selections that are any combination of (a) truly random, such as a random number generated by a random physical process, e.g., radioactive decay; (b) pseudo-random, such as a computer-generated random selection; (c) semi-random, including constraints in a selection process such as database size, and (d) quasi-random, such as a selection of n items that fills n-space more uniformly than uncorrelated random items, sometimes also called a low-discrepancy sequence. (The outputs of quasi-random sequences are generally constrained by a low-discrepancy requirement that has a net effect of points being generated in a highly correlated manner, i.e., the next point “knows” where the previous points are).

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the singular forms “a,” “an” and “the” include plural references unless the content clearly dictates otherwise.

The term “about,” as used herein, can refer to +/−10% of a value.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

### EXAMPLES

Aspects of the invention now being generally described, it will be more readily understood by reference to the following examples, which are included merely for purposes of illustration of certain aspects and embodiments of the present disclosure, and are not intended to limit the invention.

### Example 1

### Genotyping and Inference of IBD Segments

Some aspects of the present disclosure employ a likelihood ratio test for which the data are the number and lengths of autosomal genomic segments shared between two individuals, with segment length measured in centiMorgans (cM). The null hypothesis is that the individuals are no more related than two persons picked at random from the population; the alternative hypothesis is that the two individuals share recent ancestry. When the alternative model is not significantly more likely than the null model, it is concluded that there is no evidence for recent shared ancestry. Otherwise, the maximum-likelihood estimate for the degree of relationship between two individuals by maximizing the likelihood over all possible relationships is obtained in the alternative model. Significance levels and confidence intervals are determined from standard chi-square approximations for the likelihood ratio test.

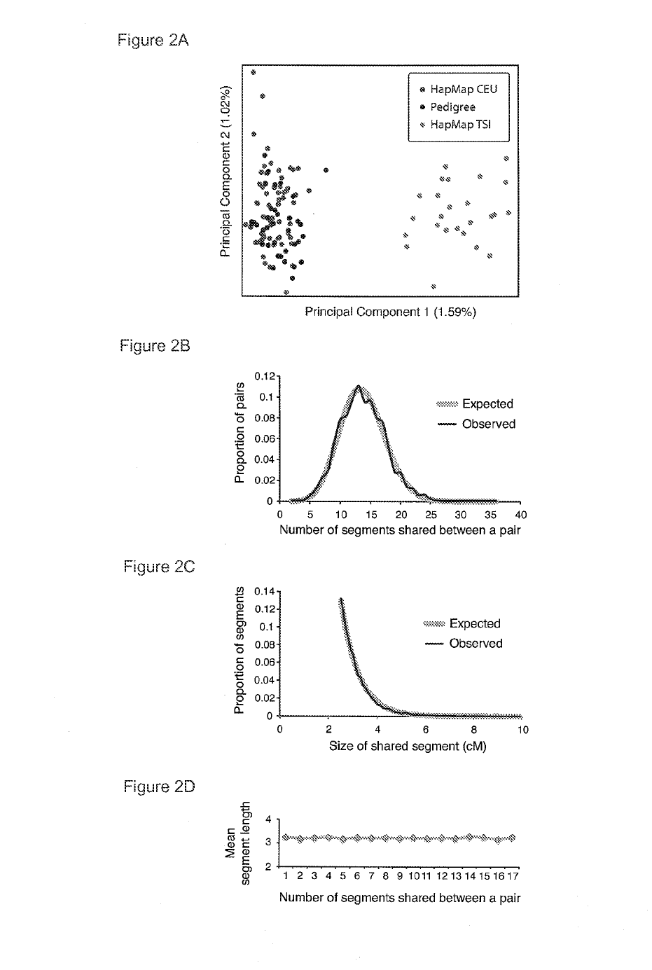

An embodiment of ERSA according to the present disclosure was applied to three well-defined pedigrees with predominantly Northern European ancestry (Table 1). Informed consent was obtained from all study subjects, and all procedures were approved by the Western Institutional Review Board. DNA samples were collected and purified from blood as described in Xing et al. (2010). Affymetrix 6.0 SNP arrays were used to genotype 169 individuals selected from these pedigrees (Table 1), per the manufacturer's instructions (see Xing et al. 2010). Beagle 3.2 (Browning and Browning 2010) was used to phase and impute missing genotypes, using the Affymetrix 6.0 SNP genotypes of the 30 HapMap CEU trios as a reference (CEL files provided by Affymetrix). Of 868,155 autosomal SNP loci with unique positions on the array (not including controls, whose probe set IDs begin with ‘AFFX-SNP’), 18,610 were excluded from the final data set because they exhibited more than three Mendelian inheritance errors in the CEU trios or more than 10% missing data in either the CEU or pedigree individuals. On the basis of the pedigree genotypes, GERMLINE 1.4.1 (Gusev et al. 2009; software available on Columbia University's Computer Science webpage (Gusev; GERMLINE)) inferred the locations and extents of IBD segments for all pairs of individuals (parameters err_het=2, err_hom=1, and min_m=1cM, with marker positions given on the HapMap r22 genetic map). GERMLINE identifies short regions of exact matches between haplotypes using a library of short seeds, then extends and merges those regions using an efficient hashing and matching algorithm. ERSA was applied to the output of GERMLINE. The program fastIBD in Beagle vers. 3.3 (Browning, University of Washington website) was also used to generate IBD segments for analysis by ERSA (default options). Although principal component analysis (FIG. 2A) can distinguish the closely-related HapMap CEU and TSI sample sets, the pedigree and HapMap CEU samples are indistinguishable.

### Methods

### A. Null Hypothesis

The likelihood of the null hypothesis is estimated from the empirical distribution of autosomal shared segments in the population. Only shared segments longer than a given threshold, t, are considered because shorter segments are more difficult to detect and provide little information about recent ancestry. Let s equal the set of segments shared between two individuals and n equal the number of elements in s. For this calculation, it is assumed that the number of segments shared and the length of each segment are independent, which is approximately true for the HapMap CEU population (see FIG. 2D). The likelihood of the null hypothesis is:

L_{P}(n,s|t)=N_{P}(n|t)·S_{P}(s|t), 1.

where

$${S}_{P} ( s \vert t ) = {\prod }_{i ∈ s}^{ } {F}_{P} ( i \vert t ) . \qquad 2.$$

N_{P}(n|t) is the likelihood of sharing n segments, S_{P}(s|t) is the likelihood of the set of segments s, and F_{P}(i|t) is the likelihood of a segment of length i. N_{P}(n|t) is approximated from a Poisson distribution with mean equal to the sample mean of the number of segments shared in the population (FIG. 2B). Under a model of random mating and complete ascertainment of shared segments, F_{P}(i|t) specifies a geometric distribution, for which an exponential approximation is substituted.

The variable t is set to the smallest value that can achieve a false-negative rate of 1% or lower. This setting maximizes the use of available data while ensuring that the exponential approximation to the distribution of segment lengths in the population holds. Here, the choice of t=2.5 cM was based on GERMLINE's previously reported false-negative rate of 1% for segments 2.5 cM and longer (Gusev et al. 2009). In the HapMap CEU population, the distribution of segments detected by GERMLINE that are longer than 2.5 cM is approximately exponential, with the exception of a few significant outliers (FIG. 2C). These outlying segments (those longer than h=10 cM) are excluded when estimating the population distribution of shared segment lengths for two reasons. First, the outliers are inconsistent with the assumption of random mating used in the approximation. Second, the outliers are examples of shared recent ancestry, and including them in the population distribution would decrease the power to detect recent ancestry. Therefore, F_{P}(i|t) is approximated from the maximum likelihood estimate of the mean of a truncated exponential distribution:

$${F}_{P} ( i \vert t ) = \frac{{e}^{- ( i - t ) / θ}}{θ} . \qquad 3.$$

where θ is equal to the mean shared segment length in the population for all segments of size greater than t and less than h. For HapMap CEU with t=2.5 cM and h=10 cM, the estimate of θ is 3.12 cM.

### B. Alternative Hypothesis

The alternative hypothesis is that the pair of individuals share either one or two recent ancestors. Let a represent the number of ancestors shared, and let d equal the combined number of generations separating the individuals from their ancestors(s), e.g., d=6 and a=1 for half-second cousins. Under the alternative hypothesis, segments shared by two individuals come from two sources: recent ancestry and the population background (denoted by subscripts A and P, respectively). Let n_{P}+n_{A}=n, where n_{A} is equal to the number of shared segments inherited from recent ancestors, and n_{P} is the number of segments shared due to the population background. s_{P} and s_{A} are two mutually exclusive subsets of s, with s_{A} equal to the subset of segments inherited from recent ancestor(s) with n_{A} elements and s_{P} equal to the subset of segments shared due to the background with n_{P} elements. The likelihood of the alternative hypothesis of recent ancestry, L_{R}, is then:

L_{R}=L_{A}(n_{A},s_{A}|d,a,t)L_{P}(n_{P},s_{P}|t). 4.

Because s_{P} is distributed according to the population distribution, L_{P} follows the description in Eq. 1. L_{A} is the likelihood that two individuals share n autosomal segments from recent ancestor(s) specified by d and a, with the segment lengths specified by s_{A}. L_{A} can be expressed as the product of likelihoods of the number of shared segments and the length of each segment, which parallels Eqs. 1 and 2:

$$\begin{matrix}{L}_{A} ( {n}_{A} , {s}_{A} \vert d , a , t ) = {N}_{A} ( n \vert d , a , t ) \cdot {S}_{A} ( {s}_{A} \vert d , t ) . & 5. \\ {S}_{A} ( s \vert d , t ) = {\prod }_{i ∈ s}^{ } {F}_{A} ( i \vert t ) . & 6.\end{matrix}$$

Eq. 6 assumes that, for a given value of d, the lengths of segments are independent. This assumption is not strictly true. One might imagine that the presence of a particularly long segment would reduce the genomic space available for additional segments. However because the length of any one segment is small relative to the length of the genome, and because the genome is physically divided into chromosomes, the segment lengths are approximately independent (Thomas et al. 1994).

For two individuals who are related by an inheritance path that is d meioses long, the probability that they will inherit any particular autosomal segment from a common ancestor on that path is equal to ½^{d-1}. The expected number of shared autosomal segments that could potentially be inherited from a common ancestor is equal to rd+c, where c is the number of autosomes and r is the expected number of recombination events per haploid genome per generation. Therefore, the expected number of shared segments is equal to a(rd+c)/2^{d-1} (Thomas et al. 1994). In humans, c is equal to 22 and r is approximately 35.3 (McVean et al. 2004). Given d, the expected value of i is 100/d. Without conditioning on t, the distribution of segment length is exponential with mean 100/d. Conditioning on t,

$${F}_{A} ( i \vert d , t ) = \frac{{e}^{- d ( i - t ) / 100}}{100 / d} . \qquad 7.$$

The probability that a shared segment is longer than t, p(t), is equal to e^{-dt/100} (Thomas et al. 1994). Because the distribution of the number of shared segments is approximately Poisson (Thomas et al. 1994),

$${N}_{A} ( n \vert d , a , t ) = \frac{{{e}^{\frac{- a ( r d + c ) p ( t )}{{2}^{d - 1}}} [ \frac{a ( r d + c ) p ( t )}{{2}^{d - 1}} ]}^{n}}{n !} . \qquad 8.$$

Given n_{A} and n_{P}, the maximum value of the likelihood function (Eq. 4) is equal to:

$${ML}_{R} ( {n}_{P} , {n}_{A} , s \vert d , a , t ) = {N}_{P} ( {n}_{P} \vert t ) {N}_{A} ( {n}_{A} \vert d , a , t ) \cdot {S}_{P} ( \{ {s}_{1 : n } … {s}_{{n}_{P : n}} \} \vert t ) {S}_{A} ( \{ {s}_{{n}_{P} + 1 : n} … {s}_{n : n} \} \vert d , a , t ) \qquad 9.$$

where s_{x:n} is equal to the x^{th} smallest value in s. Eq. 9 asserts that the likelihood is maximized when the set of segments resulting from recent ancestry is equal to the longest n_{A} segments in s, with the remaining n_{P} segments being due to the population background.

The alternative model contains three additional parameters relative to the null model, d, a, and n_{A} (n_{P}=n−n_{A}). However, when the behavior of d and a was evaluated empirically, it was found that they effectively act as a single parameter (FIG. 10). Therefore, the ratio of Eq. 1 and Eq. 9 was evaluated using a χ² approximation with two degrees of freedom (−2 ln [L_{R}/L_{N}]˜χ₂²). For closely related individuals, the distribution of N_{P}(n_{P}|t) should theoretically be adjusted to account for segments shared from the population background that could not be observed because they occur within longer segments shared due to recent ancestry. Although ERSA optionally includes this adjustment, the algorithm performs slightly better without the adjustment due to the occasional imprecise definition of very long IBD segments in GERMLINE. To identify the maximum value of the likelihood function (Eq. 4) given d, a, and t, all possible values of n_{P} and n_{A} are evaluated in Eq. 9:

ML_{R}(n,s|d,a,t)=Max{ML_{R}(n_{P},n−n_{P},s):n_{P} ∈ {0,1 . . . n}}. 10.

a. Individuals Ascertained Based on a Shared Genetic Variant

If the two individuals have been ascertained because they both share the same genetic variant, as in the case of a shared disease-causing variant, then the likelihood calculation must be conditioned on this ascertainment. In the case of such ascertainment, the shared segment that contains the variant is equivalent to two shared segments, with the segment boundaries defined by the original boundaries and the location of the ascertained variant. (Thomas et al. 2008; Thomas et al. 1994) Thomas et al. have shown that the lengths of these segments, g₁ and g₂, are exponentially distributed, with the mean equal to the unconditional length of a segment. Excluding the ascertained segment from n and s, the maximum value of the likelihood function is equal to:

AML_{R}(n,s,g₁,g₂|d,a,t)=ML_{R}(n,s|d,a,t)·Max{S_{P}({g₁,g₂}|t)S_{A}({g₁,g₂}|d,a,t)} 11.

### C. Proof of Equation 9

Equation 9 holds as long as θ<a(rd+c), which is true whenever a and d specify shared ancestry that is recent relative to pairs of individuals selected at random from the population. Given a set of shared segment lengths between two individuals, s, the objective is to identify the subset of these segments, m, containing the n_{A} elements that are most likely to have been inherited from recent ancestor(s). Eq. 9 assumes that m is equal to the largest n_{A} elements in s. Here, it is shown why this assumption holds: Let θ₁=100/d, which is the expected length of a shared segment inherited from a recent ancestor. Let θ₂=θ, which is the expected length of a shared segment if it is not inherited from a recent ancestor. If the average time to the most recent common ancestor between individuals in the population is greater than d/2, then θ₁>θ₂. If θ₁<θ₂, then individuals selected at random from the population are more closely related than the relationship being analyzed, and therefore there is no power to detect a relationship.

To demonstrate that m is equal to the set containing the largest n_{A} elements of s, consider two mutually exclusive subsets of s, z_{P} and z_{A}, with z_{A} containing n_{A} elements. Let x₁ equal the largest element in z_{P} and x₂ equal the smallest element in z_{A}. Let y_{P} and y_{A} respectively equal the sets z_{P} and z_{A}, with the exception that x₁ and x₂ are swapped. As long as x₁>x₂, the likelihood of z_{P} and z_{A} is less than the likelihood of y_{P} and y_{A}:

L_{R}(nₚ,nₐ,yₐ,yₚ|d,a,t)<L_{R}(n_{P},nₐ,z_{A},z_{P}|d,a,t).

The components of L_{R} are N_{A}, N_{P}, S_{A}, and S_{P}. Because N_{A} and N_{P} depend only on n_{P} and n_{A}, the above condition simplifies to:

S_{P}(y_{P}|t)S_{A}(y_{A}|d,a,t)<S_{P}(z_{P}|t)S_{A}(z_{A}|d,a,t).

The elements in both z_{P} and z_{A}, and y_{P} and y_{A} are equal, with the exception of x₁ and x₂. Therefore, by Eq. 6, the inequality becomes

F_{P}(x₂|t)F_{A}(x₁|d,a,t)<F_{P}(x₁|t)F_{A}(x₂|d,a,t),

which (by Eqs. 3 and 7) is equal to

$$\frac{1}{{θ}_{1}} {e}^{- \frac{{x}_{2}}{{θ}_{1}}} \frac{1}{{θ}_{2}} {e}^{- \frac{{x}_{1}}{{θ}_{2}}} < \frac{1}{{θ}_{1}} {e}^{- \frac{{x}_{1}}{{θ}_{1}}} \frac{1}{{θ}_{2}} {e}^{- \frac{{x}_{2}}{{θ}_{2}}} .$$

This simplifies to

$$\frac{{x}_{2} - {x}_{1}}{{θ}_{2}} < 0 < \frac{{x}_{1} - {x}_{2}}{{θ}_{1}} .$$

Q.E.D.

### D. Parameters d and a in the Likelihood Ratio Test

Although d and a are specified as two separate parameters in the likelihood ratio test, analyses indicated that allowing a to vary has almost no effect on the distribution of likelihood scores under the null hypothesis. To demonstrate this behavior, the likelihood scores for pairs of individuals from two closely-related populations, the CHB (45 Han Chinese in Beijing) and JPT (45 Japanese in Tokyo) samples, were evaluated using the HapMap phase 2 SNP genotype data (HapMap Consortium 2005). For each pair of individuals, the maximum likelihood for two alternative models (L₁ and L₂) was calculated. In model 1, a is allowed to vary, and in model 2, a is fixed equal to 2 (d is estimated in both). To evaluate the effect of allowing a to vary, a likelihood ratio test (LRT) statistic for the two models (−2 ln [L₁/L₂] was calculated; FIG. 10, blue (“Observed” line). For comparison, the expected cumulative distribution of a χ² with one degree of freedom was calculated (red). As the cumulative distribution illustrates, all of the observed LRT values are less than 10⁻⁸, indicating that there is very little difference between the likelihoods of the two models. Thus d and a can be treated as a single parameter when applying the χ² approximation to the likelihood ratio test statistic.

### Results

The performance of ERSA was assessed by analyzing high-density SNP microarray data on three deep, well-defined pedigrees composed of 24, 30, and 115 individuals (Table 1). The output from this analysis was a maximum-likelihood estimate and confidence interval (C.I.) for the degree of relationship of each pair of individuals in the sample. The computation time taken by ERSA to analyze all 14,196 pairs of individuals in this sample was approximately 9 minutes running on one core of a 2.3 GHz AMD Opteron processor. In FIGS. 3A and 3B present results for all 2,677 known pairs of first- through twelfth-degree relatives with exactly two known common ancestors in the pedigree and for which the two inheritance paths between the individuals have the same length (e.g., full sibs, full cousins). Results for relatives with exactly one common ancestor (e.g., half cousins) were qualitatively similar (see FIGS. 5A-5C).

For pairs of individuals as distantly related as eighth-degree relatives, ERSA's estimates are generally accurate to within one degree of the known relationship. ERSA predicted the exact degree of relationship for 66% of the 549 pairs of first- through fifth-degree relative and was accurate to within one degree of relationship for 97% of those pairs (FIGS. 3A and 3B and Table S1). Point estimates were accurate to within one degree of relationship for more than 80% of sixth- and seventh-degree relatives, and 60% of eighth-degree relatives (FIGS. 3A and 3B), but accuracy drops off rapidly beyond this point (FIGS. 3A and 3B).

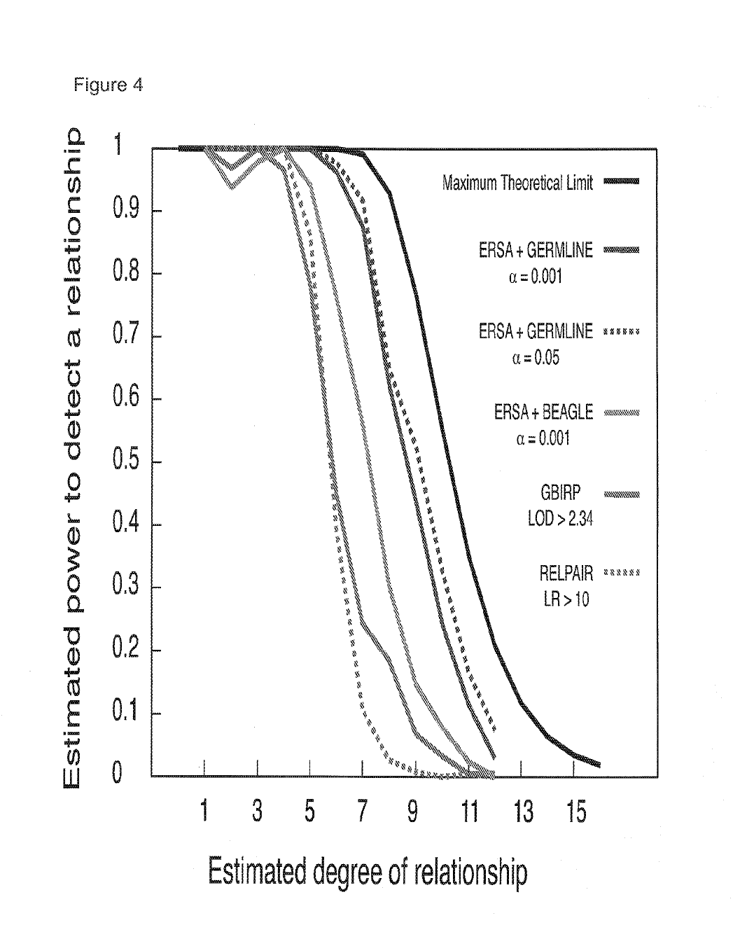

ERSA has nearly 100% power to detect first- through fifth-degree relatives and substantial power to detect ancestry as distant as eleventh-degree relatives. A significant relationship was detected among all 549 pairs of first- through fifth-degree relatives in the sample α=0.001, where the null hypothesis is no relationship (FIG. 4). Although the power to detect more distant ancestry is constrained by the fact that distant relatives often share no genetic material (Donnelly 1983), ERSA retains relatively high power for these relationships. Eighty-eight percent of seventh-degree relatives, 44% of ninth-degree relatives, and 12% of eleventh-degree relatives were detected at a significance level of 0.001 (red line in FIG. 4), which closely approaches the maximum theoretical power (black line in FIG. 4).

For comparison, the same relationships were analyzed by applying RELPAIR (Epstein et al. 2000) and GBIRP (Stankovich et al. 2005) to a subset of the SNP loci (see FIGS. 4 and 6A-6F). Both methods had high power to detect third- and fourth-degree relatives (dotted and solid blue lines in FIG. 4), although RELPAIR reports all relationships beyond second degree as simply “cousins” (i.e., more distant than second degree). The power of RELPAIR and GBIRP drops off rapidly beyond fourth-degree relationships, approximately three degrees before ERSA's power begins to decline (FIG. 4).

As shown in Table 2, ERSA's probability of detecting a significant relationship between unrelated individuals (the empirical false positive rate) is approximately equal to the nominal significance level (α). To estimate the empirical false positive rate, high-density SNP data on a set of individuals with no recent shared ancestry was needed. Given the sensitivity of ERSA to distant relationships, acquiring an appropriate dataset from pedigree data would require complete ancestry information for each individual in the sample extending back at least seven generations. Because such pedigrees are extremely rare, the false positive rate from two closely related populations, the CHB (45 Han Chinese in Beijing) and JPT (45 Japanese in Tokyo) samples, using the HapMap phase 2 SNP genotype data was estimated (HapMap Consortium 2005). Because these populations can be distinguished genetically (HapMap Consortium 2005), estimating the false positive rate from the CHB-JPT comparison is not ideal. However, the allele frequency and haplotype distributions of these populations are very similar (HapMap Consortium 2005), and pairs of CHB and JPT individuals are unlikely to have shared an ancestor in the past 200 years. Therefore, false-positive rates from the proportions of CHB-JPT pairs in which significant recent ancestry was detected was estimated. The estimated false positive rates closely matched the nominal rates (Table 2). For the significance level of α=0.001 used in FIGS. 3A, 3B, and 4, the estimated false positive rate was 0.0005 (95% C.I. 1.3×10⁻⁵ to 0.0028).

ERSA can also accurately detect relationships between individuals who share a disease-causing mutation transmitted from a common founder. The process of ascertaining individuals based on a shared mutation introduces biases in the estimation of recent ancestry, but this bias can be taken into account (see Methods). The test case was composed of seven previously described individuals who are affected with attenuated familial adenomatous polyposis (AFAP) due to a single disease-causing mutation (c.426_{—}427delAT in the APC gene; Neklason et al. 2008). The available pedigree information identified four pairs of these individuals as sixth-degree relatives and one pair as eighth-degree relatives. The point estimates from ERSA were accurate to within one degree of relationship for all five of these pairs.

### Discussion

ERSA uses explicit IBD segment information to estimate the relationships between pairs of individuals in a maximum-likelihood framework. This makes better use of the information present in high-density SNP genotyping data, as shown by the power curves in FIG. 4. The power of aspects of the instant invention to detect relationships between second cousins or closer relatives is essentially perfect and exceeds 85% for third cousins even at the α=0.001 level. ERSA is also more accurate than RELPAIR or GBIRP (FIGS. 6A-6F and Table S1.) Beyond third cousins, genetic methods inherently become more limited by the fact that two individuals with a common genealogical ancestor frequently do not share any genetic material inherited from that ancestor: such genealogical links cannot be directly detected by genetic methods. This limitation is illustrated in FIG. 4, which demonstrates that ERSA's power decreases in lockstep with the maximum theoretical power as the degree of relationship increases.

Because denser and more accurate genetic data will improve the ability to detect and delineate IBD segments, it is expected that the accuracy of IBD segment inference will improve as whole-genome sequencing becomes more affordable and as higher-density microarrays become available. In addition, while the IBD segment detection methods used here (GERMLINE; Gusev et al. 2009; fastIBD in Beagle 3.3) perform well, further improvements are expected as phasing and imputation methods advance (e.g., Genovese et al. 2010).

ERSA detects recent shared ancestry by identifying an excess of IBD segment-sharing relative to the population background. Therefore, the power to detect shared ancestry between individuals depends on the demographic history of the population to which those individuals belong. If the population size is small, or if the population has experienced a founder effect or recent bottleneck, then the level of IBD segment-sharing among unrelated individuals will increase. In such populations, ERSA's power to detect distant relationships will be diminished.

### Example 2

### Estimating Recent Ancestry in Admixed Populations

The pedigree samples analyzed in Example 1 are from a homogeneous population. As shown here, it is predicted that ERSA will retain its high detection power in admixed populations.

Analysis of the European samples of Example 1 demonstrates that ERSA performs well in a homogeneous population with no history of recent admixture from a more distantly related population. Because pedigree data for an admixed population was not available, ERSA's performance in the presence of admixture could not be directly analyzed. Impacts of admixture on ERSA's performance would most likely be mediated through effects on the expected distributions of the number and lengths of IBD segments shared between unrelated individuals. Admixture should reduce the number and lengths of such segments. The reasoning for this expected reduction is as follows. The detection of IBD segments is based largely on long runs of consecutive loci at which the genotypes are consistent with identity-by-state (IBS). Admixture will introduce alleles that are frequently IBS among pairs of individuals in the population due to shared ancestry. However, in the absence of founder effect, given that two admixed individuals are of identical ancestry at a particular genomic segment, they are no more likely to share long runs of IBS than individuals chosen at random from the appropriate reference population. When individuals are not required to share ancestry at any particular genomic segment (as would be the case for ascertainment for a shared genetic disease), it results in an expectation of fewer and smaller shared segments among unrelated individuals relative to at least one of the reference populations.

This prediction was tested by comparing individuals from a sample of 25 Bolivian individuals genotyped on Affymetrix SNP 6.0 arrays (Xing et al. 2010). Substantial European admixture (19-41%; data not shown) in 9 Bolivians was identified using the Admixture software (Alexander et al. 2009). The Bolivian population was divided into groups with and without admixture. All non-admixed Bolivians were estimated to have <0.1% admixture. The same process was then applied to identify shared segments in the European sample, i.e., using Beagle (Browning and Browning 2010) to phase and impute the data and GERMLINE (Gusev et al. 2009) to identify all shared segments longer than 2.5 cM. Consistent with predictions, on average, the admixed Bolivians shared 43 segments (95% C.I. 41-45 segments) with an average size of 3.5 cM (95% C.I. 3.4-3.7 cM), compared to 88 segments (95% C.I. 86-92 segments) with an average size of 4.2 cM (95% C.I. 4.1-4.3 cM) in non-admixed Bolivians.

In comparisons of distantly-related admixed individuals, the smaller expected number and size of background segments could slightly improve ERSA's detection power: short but meaningful shared IBD segments could become statistically significant when compared to a shorter background size distribution. In comparisons of distantly-related individuals with ancestries mostly confined to one of the reference populations, however, the admixed population background distributions would be incorrect. Using them might cause ERSA to suffer a slightly increased false positive rate or a bias towards overestimating the degree of relationship due to the misattribution of some short background segments to a distant relationship.

### Example 3

### Inferring First-Degree Relationships

Many existing methods for detecting IBD segments do not distinguish segments that overlap on homologous chromosomes, and rather than consider them to be separate, merge them into one (see FIG. 9). For two or more degrees of relationship, Eqs. 7 and 8 provide close approximations to the results of this procedure (Thomas et al. 2008). However, in the case of full siblings, Eq. 7 systematically overestimates the number of detected shared segments, and Eq. 8 systematically underestimates the length of the merged segment. Therefore, for d=2 and a=2, the calculation for N_{A} and F_{A} was adjusted to account for shared segments that have been bioinformatically merged:

$$\begin{matrix}{N}_{A} ( n \vert d = 2 , a = 2 ) = \frac{{{e}^{- \frac{3}{4} c + 2 dr \frac{3}{4} \cdot \frac{1}{4}} [ \frac{3}{4} c + 2 dr \frac{3}{4} \cdot \frac{1}{4} ]}^{n}}{n !} . & S1 . \\ {F}_{A} ( i \vert d = 2 , a = 2 , t ) = \frac{{( i - t )}^{\hat{k} - 1} {e}^{- d ( i - t ) / 100}}{{( 100 / d )}^{\hat{k}} ( \hat{k} - 1 ) !} , & S2 .\end{matrix}$$

where \hat{k} is the maximum likelihood estimate for the number of merged segments. Because Eq. S2 introduces additional estimated parameters into the full-sibling model, ERSA only reports the full-sibling model as the maximum likelihood estimate if it is significantly more likely than all other models at the 0.05 level.

ERSA is designed to detect ancestry at a single node in a pedigree; incorporating information about human biodiversity (HBD) would result in a near-perfect detection of full sibling relationships, but would have little to no effect on estimates of other relationships. HBD information will be incorporated into future evaluation of full-sibling models as the tools for IBD and HBD segment detection improve.

Many existing IBD methods are also unable to detect the recombination breakpoints between parent-offspring pairs and usually report the length of each entire chromosome as a shared segment (Gusev et al. 2009; Thomas et al. 2008). With this detection scheme, a probabilistic description of the number and size of shared segments is no longer appropriate. Therefore, to identify parent-offspring relationships, a different statistic, the total proportion of the genome shared between the two individuals, was considered. A sibling relationship is rejected in favor of a parent-offspring relationship when the proportion of the genome shared exceeds a specified significance level for siblings (default is 0.01). ERSA includes options to bypass Eqs. S1, S2, and/or the parent-offspring option for situations where the overlapping segments can be accurately identified.

### REFERENCES

ALEXANDER, D. H., NOVEMBRE, J., AND LANGE, K. 2009. FAST MODEL-BASED ESTIMATION OF ANCESTRY IN UNRELATED INDIVIDUALS. GENOME RES 19: 1655-1664.

ALONSO, A., MARTIN, P., ALBARRAN, C., GARCIA, P., FERNANDEZ DE SIMON, L., JESUS ITURRALDE, M., FERNANDEZ-RODRIGUEZ, A., ATIENZA, I., CAPILLA, J., GARCIA-HIRSCHFELD, J. ET AL. 2005. CHALLENGES OF DNA PROFILING IN MASS DISASTER INVESTIGATIONS. CROAT MED J 46: 540-548.

BERKOVIC, S. F., DIBBENS, L. M., OSHLACK, A., SILVER, J. D., KATERELOS, M., YEARS, D. F., LULLMANN-RAUCH, R., BLANZ, J., ZHANG, K. W., STANKOVICH, J. ET AL. 2008. ARRAY-BASED GENE DISCOVERY WITH THREE UNRELATED SUBJECTS SHOWS SCARB2/LIMP-2 DEFICIENCY CAUSES MYOCLONUS EPILEPSY AND GLOMERULOSCLEROSIS. AM J HUM GENET 82: 673-684.

BIEBER, F. R., BRENNER, C. H., AND LAZER, D. 2006. FINDING CRIMINALS THROUGH DNA OF THEIR RELATIVES. SCIENCE 312: 1315-1316.

BIESECKER, L. G., BAILEY-WILSON, J. E., BALLANTYNE, J., BAUM, H., BIEBER, F. R., BRENNER, C., BUDOWLE, B., BUTLER, J. M., CARMODY, G., CONNEALLY, P. M. ET AL. 2005. EPIDEMIOLOGY. DNA IDENTIFICATIONS AFTER THE 9/11 WORLD TRADE CENTER ATTACK. SCIENCE 310: 1122-1123.

BOEHNKE, M. AND COX, N. J. 1997. ACCURATE INFERENCE OF RELATIONSHIPS IN SIB-PAIR LINKAGE STUDIES. THE AMERICAN JOURNAL OF HUMAN GENETICS 61: 423-429.

BRENNER, C. H. 2006. SOME MATHEMATICAL PROBLEMS IN THE DNA IDENTIFICATION OF VICTIMS IN THE 2004 TSUNAMI AND SIMILAR MASS FATALITIES. FORENSIC SCI INT 157: 172-180.

BROWNING, S. R. AND BROWNING, B. L. 2010. HIGH-RESOLUTION DETECTION OF IDENTITY BY DESCENT IN UNRELATED INDIVIDUALS. THE AMERICAN JOURNAL OF HUMAN GENETICS 86: 526-539.

BUDIMLIJA, Z. M., PRINZ, M. K., ZELSON-MUNDORFF, A., WIERSEMA, J., BARTELINK, E., MACKINNON, G., NAZZARUOLO, B. L., ESTACIO, S. M., HENNESSEY, M. J., AND SHALER, R. C. 2003. WORLD TRADE CENTER HUMAN IDENTIFICATION PROJECT: EXPERIENCES WITH INDIVIDUAL BODY IDENTIFICATION CASES. CROAT MED J 44: 259-263.

CASH, H. D., HOYLE, J. W., AND SUTTON, A. J. 2003. DEVELOPMENT UNDER EXTREME CONDITIONS: FORENSIC BIOINFORMATICS IN THE WAKE OF THE WORLD TRADE CENTER DISASTER. PAC SYMP BIOCOMPUT: 638-653.

CHERNY, S. S., ABECASIS, G. R., COOKSON, W. O., SHAM, P. C., AND CARDON, L. R. 2001. THE EFFECT OF GENOTYPE AND PEDIGREE ERROR ON LINKAGE ANALYSIS: ANALYSIS OF THREE ASTHMA GENOME SCANS. GENET EPIDEMIOL 21 SUPPL 1: S117-122.

INTERNATIONAL HAPMAP CONSORTIUM 2005. A HAPLOTYPE MAP OF THE HUMAN GENOME. NATURE 437: 1299-1320.

DEWOODY, J. A. 2005. MOLECULAR APPROACHES TO THE STUDY OF PARENTAGE, RELATEDNESS, AND FITNESS: PRACTICAL APPLICATIONS FOR WILD ANIMALS. THE JOURNAL OF WILDLIFE MANAGEMENT 69: 1400-1418.

DONNELLY, K. P. 1983. THE PROBABILITY THAT RELATED INDIVIDUALS SHARE SOME SECTION OF GENOME IDENTICAL BY DESCENT. THEOR POPUL BIOL 23: 34-63.

EPSTEIN, M. P., DUREN, W. L., AND BOEHNKE, M. 2000. IMPROVED INFERENCE OF RELATIONSHIP FOR PAIRS OF INDIVIDUALS. THE AMERICAN JOURNAL OF HUMAN GENETICS 67: 1219-1231.

GENOVESE, G., LEIBON, G., POLLAK, M., AND ROCKMORE, D. 2010. IMPROVED IBD DETECTION USING INCOMPLETE HAPLOTYPE INFORMATION. BMC GENETICS 11: 58.

GUSEV, A., LOWE, J. K., STOFFEL, M., DALY, M. J., ALTSHULER, D., BRESLOW, J. L., FRIEDMAN, J. M., AND PE'ER, I. 2009. WHOLE POPULATION, GENOME-WIDE MAPPING OF HIDDEN RELATEDNESS. GENOME RESEARCH 19: 318-326.

LECLAIR, B. 2004. LARGE-SCALE COMPARATIVE GENOTYPING AND KINSHIP ANALYSIS: EVOLUTION IN ITS USE FOR HUMAN IDENTIFICATION IN MASS FATALITY INCIDENTS AND MISSING PERSONS DATABASING. PROGRESS IN FORENSIC GENETICS 10: 42-44.

LECLAIR, B., SHALER, R., CARMODY, G. R., ELIASON, K., HENDRICKSON, B. C., JUDKINS, T., NORTON, M. J., SEARS, C., AND SCHOLL, T. 2007. BIOINFORMATICS AND HUMAN IDENTIFICATION IN MASS FATALITY INCIDENTS: THE WORLD TRADE CENTER DISASTER. J FORENSIC SCI 52: 806-819.

MCPEEK, M. S. AND SUN, L. 2000. STATISTICAL TESTS FOR DETECTION OF MISSPECIFIED RELATIONSHIPS BY USE OF GENOME-SCREEN DATA. THE AMERICAN JOURNAL OF HUMAN GENETICS 66: 1076-1094.

MCVEAN, G. A. T., MYERS, S. R., HUNT, S., DELOUKAS, P., BENTLEY, D. R., AND DONNELLY, P. 2004. THE FINE-SCALE STRUCTURE OF RECOMBINATION RATE VARIATION IN THE HUMAN GENOME. SCIENCE 304: 581-584.

NEKLASON, D. W., STEVENS, J., BOUCHER, K. M., KERBER, R. A., MATSUNAMI, N., BARLOW, J., MINEAU, G., LEPPERT, M. F., AND BURT, R. W. 2008. AMERICAN FOUNDER MUTATION FOR ATTENUATED FAMILIAL ADENOMATOUS POLYPOSIS. CLIN GASTROENTEROL HEPATOL 6: 46-52.

PEMBERTON, T. J., WANG, C., LI, J. Z., AND ROSENBERG, N. A. 2010. INFERENCE OF UNEXPECTED GENETIC RELATEDNESS AMONG INDIVIDUALS IN HAPMAP PHASE III. AM J HUM GENET 87: 457-464.

PURCELL, S., NEALE, B., TODD-BROWN, K., THOMAS, L., FERREIRA, M. A. R., BENDER, D., MALLER, J., SKLAR, P., DE BAKKER, P. I. W., DALY, M. J. ET AL. 2007. PLINK: A TOOL SET FOR WHOLE-GENOME ASSOCIATION AND POPULATION-BASED LINKAGE ANALYSES. THE AMERICAN JOURNAL OF HUMAN GENETICS 81: 559-575.

SIMONSON, T. S., YANG, Y., HUFF, C. D., YUN, H., QIN, G., WITHERSPOON, D. J., BAI, Z., LORENZO, F. R., XING, J., JORDE, L. B. ET AL. 2010. GENETIC EVIDENCE FOR HIGH-ALTITUDE ADAPTATION IN TIBET. SCIENCE 329: 72-75.

SLATE, J., SANTURE, A. W., FEULNER, P. G. D., BROWN, E. A., BALL, A. D., JOHNSTON, S. E., AND GRATTEN, J. 2010. GENOME MAPPING IN INTENSIVELY STUDIED WILD VERTEBRATE POPULATIONS. TRENDS IN GENETICS 26: 275-284. XXVI. STANKOVICH, J., BAHLO, M., RUBIO, J. P., WILKINSON, C. R., THOMSON, R., BANKS, A., RING, M., FOOTE, S. J., AND SPEED, T. P. 2005. IDENTIFYING NINETEENTH CENTURY GENEALOGICAL LINKS FROM GENOTYPES. HUM GENET 117: 188-199.

SUN, L., WILDER, K., AND MCPEEK, M. S. 2002. ENHANCED PEDIGREE ERROR DETECTION. HUM HERED 54: 99-110.

THOMAS, A., CAMP, N. J., FARNHAM, J. M., ALLEN-BRADY, K., AND CANNON-ALBRIGHT, L. A. 2008. SHARED GENOMIC SEGMENT ANALYSIS. MAPPING DISEASE PREDISPOSITION GENES IN EXTENDED PEDIGREES USING SNP GENOTYPE ASSAYS. ANNALS OF HUMAN GENETICS 72: 279-287.

THOMAS, A., SKOLNICK, M. H., AND LEWIS, C. M. 1994. GENOMIC MISMATCH SCANNING IN PEDIGREES. MATHEMATICAL MEDICINE AND BIOLOGY 11: 1-16.

VOIGHT, B. F. AND PRITCHARD, J. K. 2005. CONFOUNDING FROM CRYPTIC RELATEDNESS IN CASE-CONTROL ASSOCIATION STUDIES. PLOS GENET 1: E32.

WEIR, B. S., ANDERSON, A. D., AND HEPLER, A. B. 2006. GENETIC RELATEDNESS ANALYSIS: MODERN DATA AND NEW CHALLENGES. NAT REV GENET 7: 771-780.

D. J. WITHERSPOON, C. D. HUFF, Y. ZHANG, W. S. WATKINS, T. S. SIMONSON, T. M. TUOHY, D. W. NEKLASON, R. W. BURT, S. L. GUTHERY, S. R. WOODWARD, AND L. B. JORDE. NOV. 5, 2010 MAXIMUM LIKELIHOOD ESTIMATION OF RECENT ANCESTRY (ERA) BETWEEN PAIRS OF INDIVIDUALS USING HIGH-DENSITY SNP-GENOTYPING MICROARRAY DATA. AMERICAN SOCIETY OF HUMAN GENETICS 2010 ANNUAL MEETING.

XING, J., WATKINS, W. S., SHLIEN, A., WALKER, E., HUFF, C. D., WITHERSPOON, D. J., ZHANG, Y., SIMONSON, T. S., WEISS, R. B., SCHIFFMAN, J. D. ET AL. 2010. TOWARD A MORE UNIFORM SAMPLING OF HUMAN GENETIC DIVERSITY: A SURVEY OF WORLDWIDE POPULATIONS BY HIGH-DENSITY GENOTYPING. GENOMICS 96: 199-210.

ZUPANIC PAJNIC, I., GORNJAK POGORELC, B., AND BALAZIC, J. 2010. MOLECULAR GENETIC IDENTIFICATION OF SKELETAL REMAINS FROM THE SECOND WORLD WAR KONFIN I MASS GRAVE IN SLOVENIA. INT J LEGAL MED 124: 307-317.

What is claimed is:

1. A method of estimating genetic relatedness between members of a first pair of conspecific organisms, the method comprising:
receiving, by a processor, a value indicating a number of nonoverlapping polynucleotide segments longer than a threshold length (t) that are identical, by at least about 90 percent sequence identity, between members of the first pair;
receiving, by a processor, values indicating lengths of the identical segments;
comparing the number of the first pair's identical segments to a number of nonoverlapping polynucleotide segments longer than t that are identical, by at least about 90 percent sequence identity, between members of a second pair of organisms, the members of the second pair having an established degree of genetic relatedness to each other;
comparing the lengths of the first pair's identical segments to lengths of nonoverlapping polynucleotide segments longer than t that are identical, by at least about 90 percent sequence identity, between members of a third pair of organisms, the members of the third pair having an established degree of genetic relatedness to each other;
based on the number comparison and the length comparison, estimating, by a processor, a degree of genetic relatedness between the members of the first pair.

2. The method of claim 1, wherein the members of the first pair are human.

3. The method of claim 1, wherein the first pair's polynucleotide segments comprise DNA, mitochondrial DNA, sex-linked nucleotide segments, or RNA.

4. The method of claim 1, wherein t is equal to or greater than about 2.5 cM.

5. The method of claim 1, further comprising:
comparing the lengths of the first pair's identical segments to a background distribution of lengths of nonoverlapping polynucleotide segments longer than t that are identical, by at least about 90 percent sequence identity, between members of pairs of organisms in a background group, the members of most pairs in the background group being more distantly related than fourth cousins; and
wherein the estimating is further based on the comparison of the lengths of the first pair's identical segments to the lengths in the background distribution.

6. The method of claim 5, wherein the identical segments of the background group are no longer than about 10 cM.

7. The method of claim 5, wherein members of the background group are selected randomly from a larger population.

8. The method of claim 1, wherein the estimating further comprises estimating a likelihood L_{P} that the first pair are no more related than two individuals selected randomly from a population, wherein:
L_{P}(n,s|t)=N_{P}(n|t)·S_{P}(s|t);
wherein
$${S}_{P} ( s \vert t ) = {\prod }_{i ∈ s}^{ } {F}_{P} ( i \vert t ) ;$$
wherein N_{P}(n|t) comprises the likelihood of sharing n segments, S_{P}(s|t) comprises the likelihood of the set of segments s, and F_{P}(i|t) comprises the likelihood of a segment of size i.

9. The method of claim 8, wherein F_{P}(i|t) is approximated as:
$${F}_{P} ( i \vert t ) = \frac{{e}^{- ( i - t ) / θ}}{θ} ;$$
wherein θ is equal to a mean shared segment size in the population for all segments of size greater than t and less than a maximum length.

10. The method of claim 9, wherein the maximum length is about 10 cM.

11. The method of claim 8, wherein the estimating further comprises estimating a likelihood L_{R} that the first pair share one or two ancestors, wherein:
L_{R}=L_{A}(n_{A},s_{A}|d,a,t)L_{P}(s_{P}|t);
wherein n_{P}+n_{A}=n, where n_{A} is equal to the number of shared segments inherited from ancestors, n_{P} is the number of segments shared by the population;
wherein s_{P} and s_{A} are two mutually exclusive subsets of s, where s_{A} is the subset of segments inherited from ancestor(s) with n_{A} elements, and s_{P} is the subset of segments shared by the population with n_{P} elements;
wherein a represents the number of ancestors shared, and d represents the combined number of generations separating the individuals from their ancestor(s).

12. The method of claim 11, wherein the estimating further comprises estimating a maximum likelihood of L_{R}(ML_{R}), wherein:
ML_{R}(n_{P},n_{A},s|d,a,t)=N_{P}(n_{P}|t)N_{A}(n_{A}|d,a,t)·S_{P}({s_{1:n} . . . sₙ_{_{P}}_{:n}}|t)S_{A}({sₙ_{_{P}}_{+1:n} . . . s_{n:n}}|d,a,t);
where s_{x:n} is equal to the x^{th} smallest value in s.

13. The method of claim 12, further comprising evaluating, by a processor, a ratio of ML_{R}(n_{P},n_{A},s|d,a,t) and L_{P}(n,s|t) using a chi-square approximation with two degrees of freedom.

14. The method of claim 11, wherein the estimating further comprises estimating a maximum likelihood of L_{R}(ML_{R}), wherein:
ML_{R}(n,s|d,a,t)=Max{MLR(n_{P},n−n_{P},s):n_{P} ∈ {0 . . . n}}.

15. The method of claim 8, wherein the estimating further comprises estimating a likelihood L_{A} that the first pair share n segments from ancestor(s) specified by d and a, with the segment sizes specified by s_{A}, wherein:
L_{A}(n_{A},s_{A}|d,a,t)=N_{A}(n|d,a,t)·S_{A}(s_{A}|d,a,t);
wherein
$${S}_{A} ( s \vert d , t ) = {\prod }_{i ∈ s}^{ } {F}_{A} ( i \vert t ) ;$$
wherein N_{A}(n|d,a,t) is the likelihood of sharing n segments, S_{A}(s_{A}|d,t) is the likelihood of the set of segments s_{A}, and F_{A}(i|t) is the likelihood of a segment of size i;
wherein s_{P} and s_{A} are two mutually exclusive subsets of s, where s_{A} is the subset of segments inherited from ancestor(s) with n_{A} elements, and s_{P} is the subset of segments shared by the population with n_{P} elements;
wherein n_{P}+n_{A}=n, where n_{A} is equal to the number of shared segments inherited from ancestors, n_{P} is the number of segments shared by the population;
wherein a represents the number of ancestors shared, and d represents the combined number of generations separating the individuals from their ancestor(s).

16. The method of claim 15, wherein:
$${N}_{A} ( n \vert d , a , t ) = \frac{{{e}^{- \frac{a ( r d + c ) p ( t )}{{2}^{d - 1}}} [ \frac{a ( r d + c ) p ( t )}{{2}^{d - 1}} ]}^{n}}{n !} ;$$
wherein p(t) is the probability that a shared segment is longer than t, c comprises an average number of chromosomes in the organisms, and r comprises an average number of recombination events per haploid genome in the organisms.

17. The method of claim 16, wherein p(t) is assumed to be equal to or about e^{-dt/100}.

18. The method of claim 15, wherein:
$${F}_{A} ( i \vert d , t ) = \frac{{e}^{- d ( i - t ) / 100}}{100 / d} ..$$

19. The method of claim 1, further comprising:
receiving, by a processor, values indicating locations of the identical segments;
comparing the locations of the first pair's identical segments to locations of nonoverlapping polynucleotide segments longer than t that are identical, by at least about 90 percent sequence identity, between members of a fourth pair of organisms, the members of the fourth pair having an established degree of genetic relatedness to each other; and
wherein the estimating is further based on the location comparison.

20. A computer-readable medium encoded with a computer program comprising instructions executable by a processor for estimating genetic relatedness between members of a first pair of conspecific organisms, the instructions including instruction code for:
receiving, by a processor, a value indicating a number of nonoverlapping polynucleotide segments longer than a threshold length (t) that are identical, by at least about 90 percent sequence identity, between members of the first pair;
receiving, by a processor, values indicating lengths of the identical segments;
comparing the number of the first pair's identical segments to a number of nonoverlapping polynucleotide segments longer than t that are identical, by at least about 90 percent sequence identity, between members of a second pair of organisms, the members of the second pair having an established degree of genetic relatedness to each other;
comparing the lengths of the first pair's identical segments to lengths of nonoverlapping polynucleotide segments longer than t that are identical, by at least about 90 percent sequence identity, between members of a third pair of organisms, the members of the third pair having an established degree of genetic relatedness to each other;
based on the number comparison and the length comparison, estimating, by a processor, a degree of genetic relatedness between the members of the first pair.
